(19) United States
(12) Patent Application Publication
(10) Pub. No.: US 2022/0366348 A1
(43) Pub. Date: Nov. 17, 2022

(54) DETERMINING TRUE UTILIZATION

(71) Applicant: The Fin Exploration Company, San Francisco, CA (US)

(72) Inventors: Alec DeFilippo, Syracuse, NY (US); Samuel Lessin, San Francisco, CA (US); Ben Vishny, Winnetka, IL (US); Andrew Staub, Berkeley, CA (US); Evan Lloyd, Berkeley, CA (US)

(21) Appl. No.: 17/319,925

(22) Filed: May 13, 2021

(51) Int. Cl. G06Q 10/06; G06Q 10/10; G06N 20/00

(52) U.S. Cl. CPC G06Q 10/06398; G06Q 10/1091; G06Q 10/105; G06N 20/00; G06Q 30/016

(57) ABSTRACT

Methods, systems, and apparatus, including computer programs encoded on computer storage media, for determining true utilization based on productive behaviors of operators in a digital environment. One of the methods includes automatically determining productivity for each of multiple users of an organization. Timing data for a user is received that indicates available work time for the user. Interaction data is received for the user for interactions by the user during the available work time for the user. Productivity rules for an organization of the user are received that define productivity of interactions by users of the organization. Productivity of interactions of the user is determined based on the interaction data and the productivity rules. True utilization for the user is determined based on the productivity of the interactions and the timing data. Action data is generated based on the determined true utilization action is taken based on the action data.

### BACKGROUND

### Technical Field

This specification relates to determining true utilization based on productive behaviors of operators in a digital environment.

### Background

Computer users often multitask, doing multiple things at once. A computer user may be a customer support agent who may split their time across multiple cases, such as to provide support to customers phoning in or using a chat box to obtain support. The customer support representative may spend different portions of time helping each of the customers. The customer support representative may also perform other actions on the computer that are not related to any of the customers' cases.

### SUMMARY

This specification describes technologies for determining true utilization based on productive behaviors of operators in a digital environment. True utilization can be defined as productive time divided by available operator time. These technologies include determining true utilization by using a configurable method of defining which types of interactions or sequences of interactions are productive and identifying operator interactions that are either productive or nonproductive based on configured or learned rules. All actions performed by operators can be evaluated to determine productive yield across operator time and activity, on a per-service basis.

In general, one innovative aspect of the subject matter described in this specification can be embodied in methods that include the actions of: automatically determining productivity for each of multiple users of an organization, wherein determining productivity for a respective user comprises: receiving timing data for the user indicating available work time for the user; receiving interaction data for the user for interactions occurring in multiple software services used by the user during the available work time for the user; receiving productivity rules for an organization of the user that include conditions defining productivity of interactions by users of the organization; determining productivity of interactions of the user based on the interaction data and the productivity rules; determining true utilization for the user based on the productivity of the interactions and the timing data; and generating action data based on the determined true utilization; and taking action based on the action data.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. True utilization can be determined and tracked using a low-overhead, always-on solution that captures a complete picture of operator work and objectively and consistently categorizes that work into multiple buckets (e.g., productive, nonproductive, or other categories). True utilization tracking can capture all information about productive actions and otherwise untracked time and activity to generate a complete picture of employee productivity and utilization. Productivity can be determined across systems, applications, and services. Productivity can be determined based on sequences of interactions that are determined to be productive. Different customers can configure different rules for determining productivity. Each respective customer can configure productivity rules based on what is considered productive work for the customer. Productivity and true utilization can be determined at least in part by a machine learning system. Employers can save resources by not needing to manually shadow or audit employee work days or timesheets. The system can be used to calculate or ensure accurate work hours. Employers can use calculated true utilization rather than aggregating work-related data from multiple systems and data sources to generate an estimate of employee working time. The solution can be applied, for example, to as low as 10′s of operators handling hundreds of events over a specified period (e.g., minutes or hours) and more typically at least hundreds of operators handling at least thousands of events over a specified period of time (e.g., minutes or hours). The solution can provide objective assessment of work according to a set of rules, in contrast to manual efforts that involve human users who may provide subjective assessments, especially at scale or when suffering from distraction, exhaustion, etc. The solution, by constant, allows for fair and consistent assessment of work. Productivity rules can be managed and modified, and changed productivity rules can be automatically applied to rapidly re-assess productivity retroactively or for future interactions for thousands of representatives.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example of a workforce analytics system that can be used to determine discrete time spent by customer service agents on different tasks across different systems and produce reports based on discretized time, according to some implementations of the present disclosure.

FIG. 1B shows an example of a workforce analytics manager (WAM), according to some implementations of the present disclosure.

FIG. 2 is a screenshot of a customer screen for handling cases in the workforce analytics system 100, according to some implementations of the present disclosure.

FIG. 3 is a screen shot of an example of a search analytics page for looking up customer service agent events, according to some implementations of the present disclosure.

FIG. 4 is a screen shot of an example of a dashboard for customer service agent time spent on cases, according to some implementations of the present disclosure.

FIG. 5 is a screen shot of an example of a focus events structure, according to some implementations of the present disclosure.

FIGS. 6A-6B are screen shots collectively showing an example of a true utilization page, according to some implementations of the present disclosure.

FIGS. 7A-7B are screen shots collectively showing an example of a true handle time page, according to some implementations of the present disclosure.

FIGS. 8A-8B are screen shots collectively showing an example of an outliers page, according to some implementations of the present disclosure.

FIG. 9 is a screen shot of an example of a customer service agent summary page, according to some implementations of the present disclosure.

FIG. 10A is a screen shot of an example of a process flow diagram, according to some implementations of the present disclosure.

FIG. 10B is a screen shot of an example of a process timeline, according to some implementations of the present disclosure.

FIG. 11 is a screen shot of an example of a resource analysis page, according to some implementations of the present disclosure.

FIG. 12 is a screen shot of an example of a trigger event definition page, according to some implementations of the present disclosure.

FIG. 13 is a screen shot of an example of a clickstream page, according to some implementations of the present disclosure.

FIG. 14A is a screen shot of an example of a case defining services per organization page, according to some implementations of the present disclosure.

FIG. 14B is a screen shot showing an example of a document object model (DOM) tools page, according to some implementations of the present disclosure.

FIG. 14C is a screen shot showing an example of an add DOM fingerprint page, according to some implementations of the present disclosure.

FIG. 15 is a flowchart of an example of a method for determining time spent by the customer service agent on the particular case, according to some implementations of the present disclosure.

FIG. 16 is a block diagram illustrating an environment that includes a true utilization engine.

FIG. 17 is a diagram of the components of an exemplary system for determining true utilization based on productive behaviors of operators in a digital environment.

FIG. 18 is a diagram that illustrates exemplary productivity rules for different customers.

FIG. 19 is a screen shot showing an example of a true utilization page for determining true utilization based on productive behaviors.

FIG. 20 is a flowchart of a method for determining true utilization based on productive behaviors of operators in a digital environment.

FIG. 21 is a block diagram of an example computer system used to provide computational functionalities associated with described algorithms, methods, functions, processes, flows, and procedures described in the present disclosure.

Like reference numbers and designations in the various drawings indicate like elements.

### DETAILED DESCRIPTION

Previous systems for tracking operator time have historically not had a method for accurately and automatically converting employee actions into a measure of productivity without manual oversight. Previous solutions include manual shadowing and tabulation of employee activities (e.g., time-in-motion studies). Time-in-motion studies are manual processes that can only be applied while a human observer is available to observe, so samples may be limited and additional resources (e.g., the human observer) are required.

Other previous solutions involve manual time tracking (e.g., employees self-reporting on timesheets), or naive, imprecise, and only partial time tracking performed using software with tracking restricted to the user's time within only that software's own system. Some prior solutions only observe time spent within the software's direct system or predefined partner systems, so organizations lack visibility into a full operator work day and corresponding actions. Some previous solutions only track time, not actions, and not more refined tracking such as productive actions. Additionally, previous software systems do not categorize work into productive or other buckets, rather naively assuming all time spent within their system is to be counted, or relying on the operator to manually indicate their status (which is highly inaccurate, inconsistent, and subjective).

To solve the above and other problems, a true utilization engine can be used that can analyze each operator or representative action and compare the action against historical data, learned models, and any prescribed action categorization by the operator's employer, to determine whether the action is productive. For example, sending replies to customer tickets within a case management system may get categorized as productive but typing personal emails may get categorized as unproductive. As another example, entering bug reports within an internal system may get categorized as productive. Reading blogs on unsanctioned websites may get categorized as unproductive while reading articles within a knowledge base can be categorized as productive.

True utilization metrics can be calculated to determine what percentage of a day a representative is performing productive work, such as actively working on a case and engaged productively with approved or recommended tools in order to solve the case. True utilization can be used in any digital work environment where human operators perform tasks. True utilization can be calculated across each system, application or service an operator uses, rather than within a single system or selected applications. True utilization can be used to aid understanding of whether operator actions are productive relative to the operator's broader tasks at hand such as assigned cases.

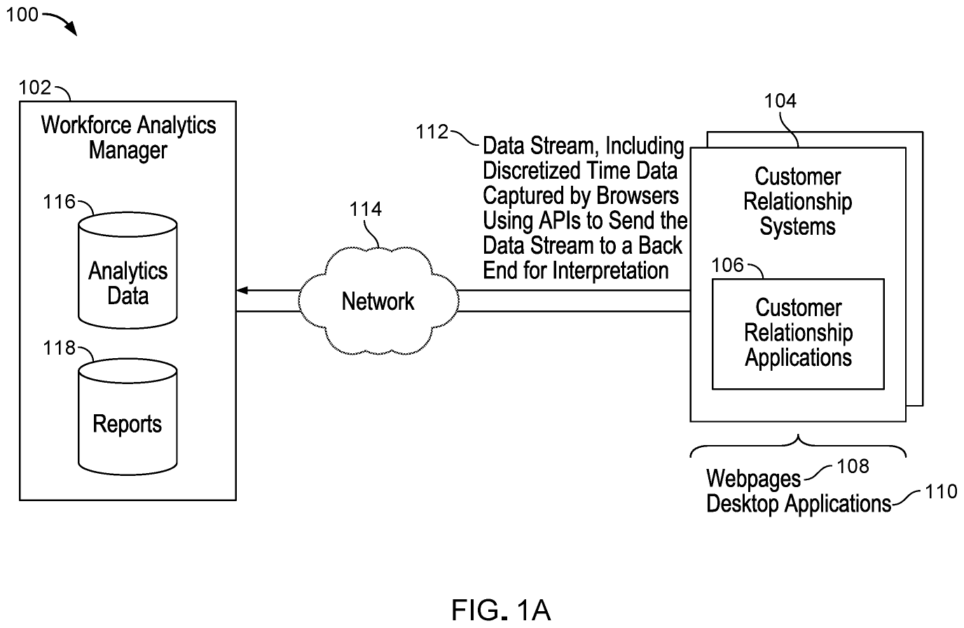

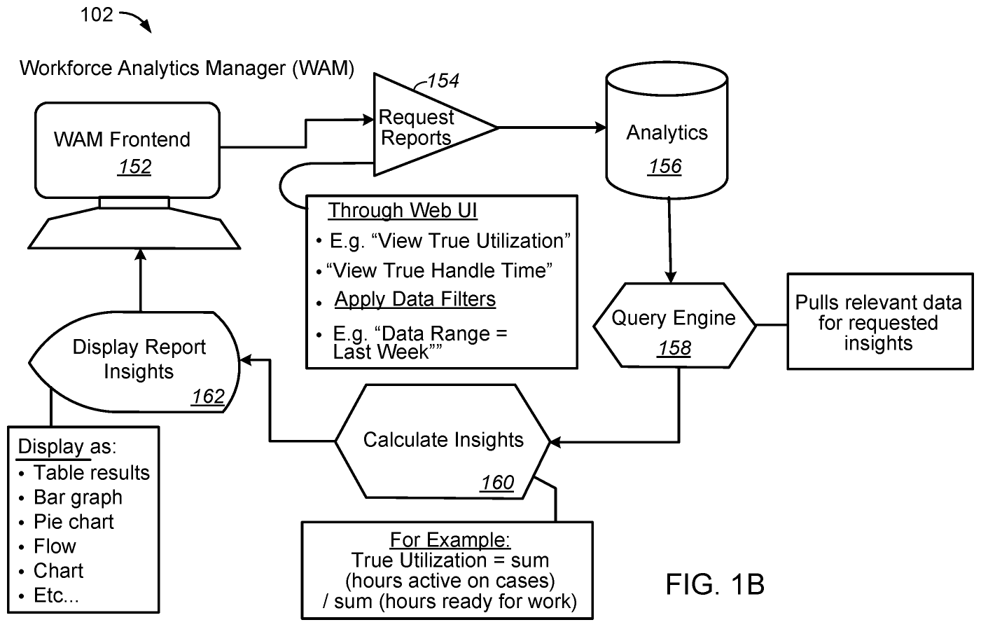

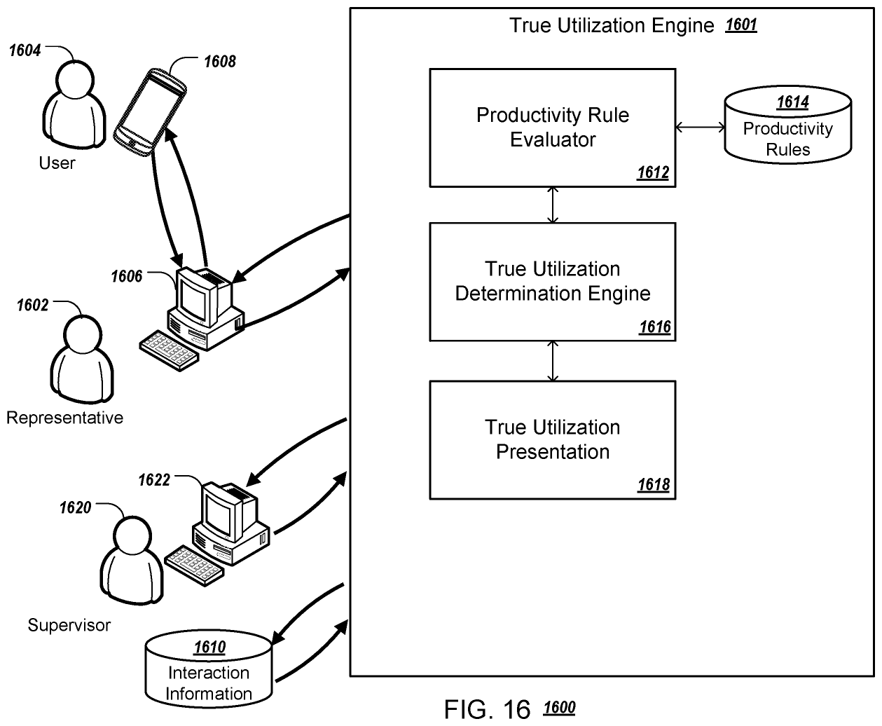

Further details and advantages of the true utilization approach are described below. For example, FIGS. 1-15 provide details regarding a workforce analytics manager for recording and managing interactions. FIGS. 16-19 provide additional details regarding determining true utilization based on productive behaviors of operators in a digital environment.

The following detailed description describes techniques for discretizing time spent by users (e.g., customer service agents) doing specific tasks on computers. These technologies generally involve associating identifiers (IDs) from different systems while users spend time handling a case spanning multiple pages and applications of the different systems. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques of the present disclosure can be used to assign each user action to a single “case” that a customer service agent is working on when the customer service agent is working simultaneously on more than one case. For example, the customer service agent can be a customer representative agent that handles Customer Relationship Management (CRM) cases that arrive at a CRM system by phone call, chat session, or online portal.

In some implementations, discretizing time can include setting identifier threshold rules, so as to define finer-grain criteria used to identify events that count as being associated with a case. Rules can also be used to define and access a set of identifiers used in set of systems that are to be tracked. Techniques of the present disclosure can be used to disregard time spent associated with identifiers that are not included in a tracked subset of systems to be tracked. Moreover, techniques of the present disclosure can be used to disregard identifiers corresponding to events that last less than a threshold event duration. Doing so can provide the benefit of avoiding an interruption of a current count of work being discretized.

Identifiers from multiple systems can be linked by observing an expected behavioral pattern of a user, such as a customer support agent. As an example, the system can determine that customer support agents generally follow a certain workflow on a given case. The identifiers used in the different systems that are accessed during the workflow can be linked together even if their linkage was previously unknown. For example, a chat application (or app) for chatting with customers may have a chat ID which is used as the case ID of the case. In a new chat, the customer support agent may use their own internal CRM system where they look up the customer. The internal CRM system may have a completely different set of identifiers, different from the chat app. If it is known that the customer support agent is always going to look up the customer in a certain amount of time after getting a new customer chat request, then the identifiers can be automatically associated or linked.

In some implementations, input context intervals (ICIs) can be used to improve the tracking of events in a more efficient way. An ICI is defined as a time interval having beginning and ending timestamps corresponding to a user action having a context (e.g., associated with a specific case). For example, events can be tracked by recording keystrokes. If the customer support agent is working on multiple cases at the same time, techniques of the present disclosure can be used to determine which case gets precedence. If a customer support agent is switching between systems, as noted above techniques of the present disclosure can link two systems that have their own case IDs but that are linked by the workflow. In order to be more efficient in linking cases and tracking time spent by customer support agents on each case, techniques of the present disclosure can be used to only allow one case to interrupt a second case if the duration of the interrupting event is above a threshold time. The threshold time can be a variable by specific situation and the system(s) that are involved. In computer systems that implement the techniques of the present disclosure, computer-implemented methods can be implemented for determining the primary task on which an agent is working when it appears that the agent is working on multiple simultaneous tasks. The computer-implemented methods can use configurable rules.

A browser in which the chat app executes can use an application programming interface (API) to send a data stream to a back end system for interpretation. APIs can be programmed to notice events that occur inside a browser or outside a browser. For example, a browser (e.g., Chrome) plugin can be implemented such that whenever an agent switches windows within a browser and visits a new page, the system records the event (e.g., the event data is sent to the backend system). A similar API can exist in Windows, for example, when an agent switches to a different window, sending event data to a server/backend. For example, the event data can indicate that the agent spent a specified amount of time on website V, or the agent spent a specified amount of time in application window X with page title Y.

In some implementations, ICIs can be implemented through the use of recording timestamps instead of just recording a time duration. In this way, the timestamps can additionally be used to correct durations corresponding to the start and end times spent on a webpage by a customer support agent. As an example, the timestamps can be fitted to key strokes that occur when a customer support agent is on a particular web page.

FIG. 1A shows an example of a workforce analytics system 100 that can be used to determine discrete time spent by customer service agents on different tasks across different systems and produce reports based on discretized time, according to some implementations of the present disclosure. The workforce analytics system 100 includes a workforce analytics manager 102 that interfaces with one or more customer relationship systems 104. Each customer relationship system 104 includes one or more customer relationship applications 106, such as CRM systems. Users (such as CRM agents) can use the customer relationship system 104, for example, by accessing webpages 108 and using desktop applications 110.

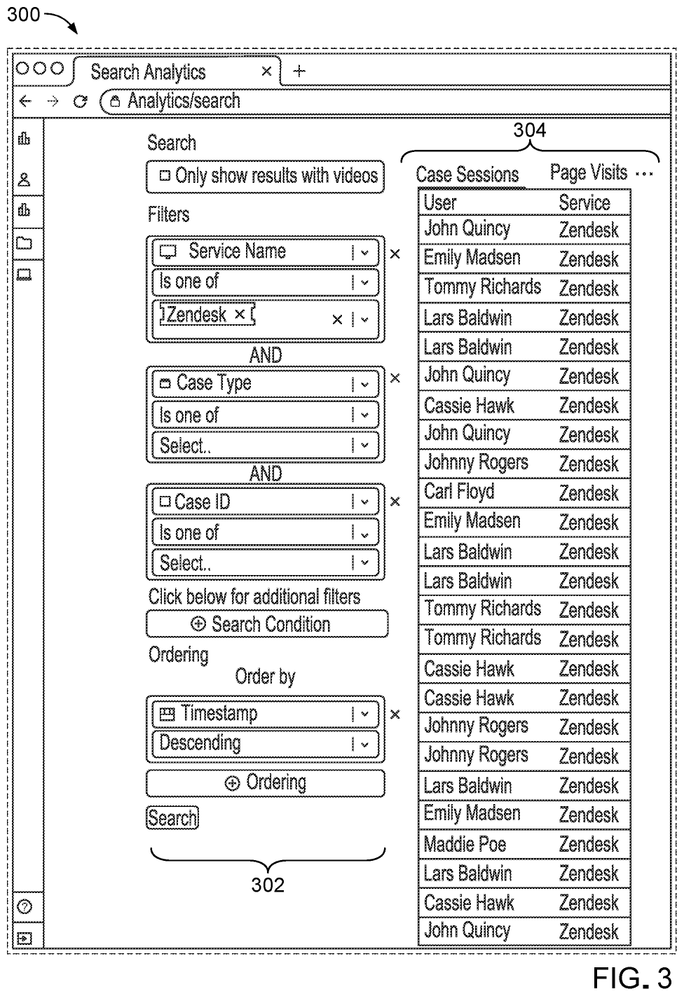

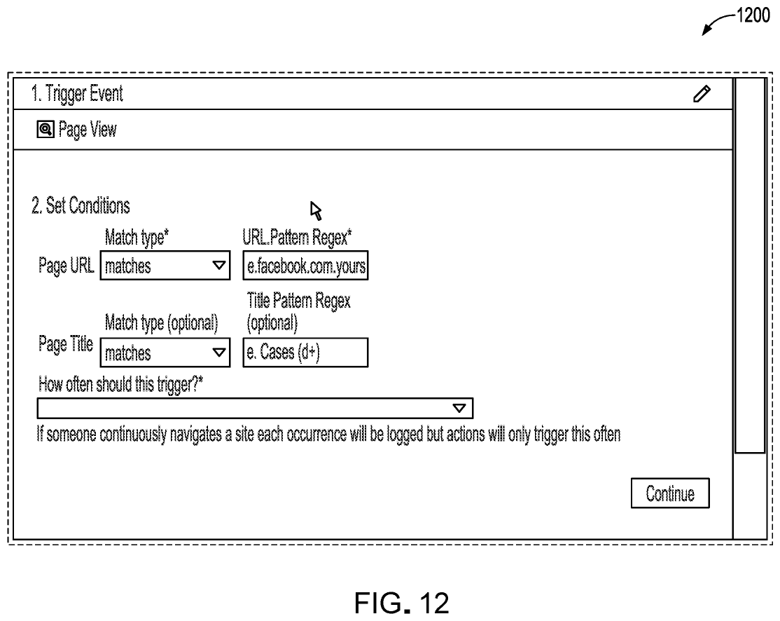

While an agent is using the customer relationship systems 104, a data stream 112 is sent to the workforce analytics manager 102 for interpretation. The data stream 112 can include discretized time data captured by browsers using APIs to send the data stream to a back end for analysis. The workforce analytics manager 102 can store the received data stream 112 as analytics data 116. The workforce analytics manager 102 can use the analytics data 116 to generate reports. The report can include, for example, reports containing information described with reference to FIGS. 3-11. Techniques by which the data stream 112 captures data include parameters and set-up operations described with reference to FIGS. 12-14C. Components of the workforce analytics system 100 are connected using a network 114 that includes, for example, combinations of the Internet, one or more wide area networks (WANs), and one or more local area networks (LANs).

Examples of reports that can be produced using discretized time data can include focus events. Focus events can be used, for example, to assign each action performed by an agent to a single “case.” An action that is assigned to a case can be disambiguated from actions performed on other cases. Discretizing the time and assigning events to specific cases can be based on cross-platform tagging for each active session. Automatic matching can occur, for example, when an agent opens a specific document within a specific period of time after opening a case. The automatic matching can use agent behavior pattern recognition that incorporates logic for timeouts, accesses to specific pages and documents, and automatic linking of identifiers from disparate systems.

The workforce analytics system 100 can perform tracking in the context of multiple workflows and multiple customers. For example, a customer service agent may have a workflow to provide a customer refund that requires the customer service agent to access a number of different systems. Based on a list or pattern of the different systems necessary for a particular type of task, workforce analytics system 100 can insure that the customer service agent follows a proper procedure while collecting metadata from each system that the customer service agent accesses and linking the metadata together.

A customer service agent may be handling multiple, simultaneously customer service cases (for example, chats) at once. Even though the time is overlapping for each of the associated customers, the workforce analytics system 100 can determine how much of their time is actually spent on each customer. The time that is tracked includes not only how much time the customer service agent is chatting with that customer, but how much time the customer service agent is spending working on that customer versus working on actions associated with another customer. The workforce analytics system 100 can use clustering algorithms and other techniques to identify that an agent is working on the same case across different systems. The clustering can occur, for example, using text copied from one box into another and based on patterns of access of different systems when handling a case.

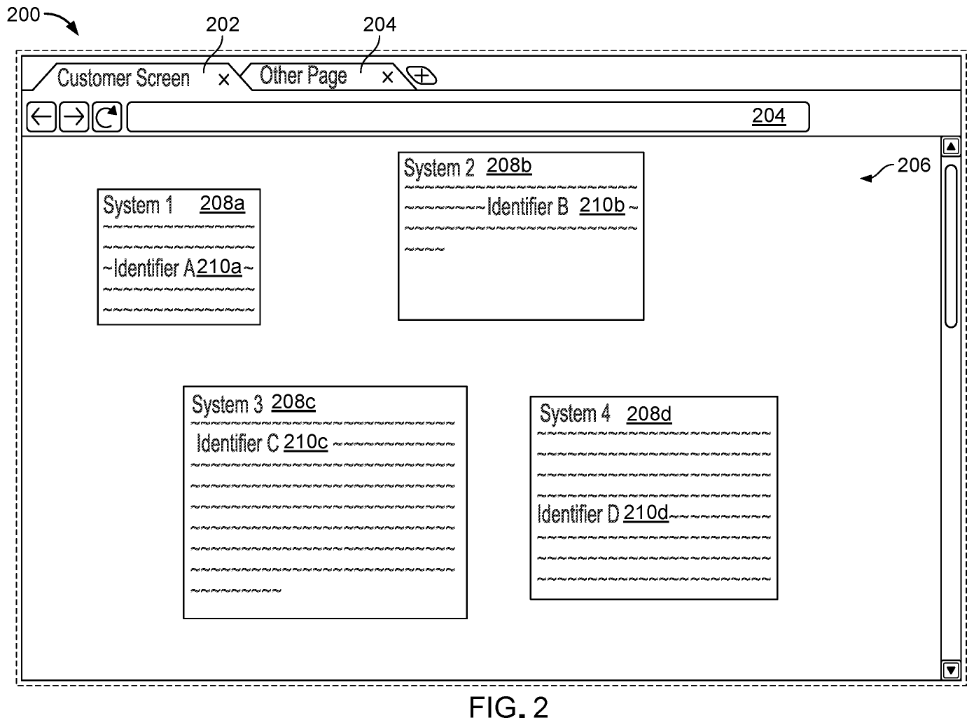

FIG. 1B shows an example of the workforce analytics manager (WAM) 102 of FIG. 1A, according to some implementations of the present disclosure. The WAM 102 includes a WAM front end 152 that provides a user interface for a user to request reports 154, for example, using analytics data 156. The analytics data 156 can include data described with reference to FIGS. 2-9. Report requests 154 can be made by a user through a web user interface (UI). Example reports can include viewing true utilization and viewing true handle time. Using the UI, the user can apply filters, including user filters and date filters (e.g., date range = last week). The analytics data 156, including user actions and event data, can serve as data input to a query engine 158 accessible through the UI for accessing relevant data for requested insights. Calculated insights 160 can be used to display report insights 162. For example, for a report providing true utilization (including user efficiency and time spent on cases), the insights can be used to create a ratio of hours active on cases and hours ready for work. Displayed reports can be displayed, for example, as table results, bar graphs, pie charts, and flow charts. Example reports are described with reference to FIGS. 2-10B.

FIG. 2 is a screenshot 200 of a customer screen 202 for handling cases in the workforce analytics system 100, according to some implementations of the present disclosure. The customer screen 202 can be an interface used by a user (for example, a customer service agent). The customer screen 202 can be one of many screens available and used in the user's browser or on the user's desktop to handle cases, including another page 204 that may present a user interface for specific products or services. An originating call, such as a chat, may originate on the customer screen 202 used by an agent. The agent may immediately or subsequently navigate to other resources, such as other pages 204, to look up the customer or perform some other action related to the case.

Working areas 206 in customer screens 202 and other pages 204 can include several pages 208a-208d (or specific screens), accessible through browsers, for example, each with corresponding identifiers 210a-210d. Other resources accessed by the customer service agent can include documents such as word documents and spreadsheets for presenting and recording information associated with a case. The identifiers 210a-210d may be completely different across the systems associated with the pages 208a-208d. However, the workforce analytics system 100 can use the analytics data 116 to associate an identifier with work done on various uncoordinated systems, which in turn can link together time spent on those different systems for the same case. The various uncoordinated systems can provide multiple software services such as web pages, documents, spreadsheets, workflows, desktop applications, and conversations on communication devices. The multiple software services include at least a software service of a first type and a software service of a second type, where the software service of the first type and the software service of the second type are uncoordinated software services lacking inter-service communication and a common identification labelling system.

In some implementations, the following steps can be used for assigning an event to a case. First, the system determines a location of a case ID or other identifier. For example, the identifier may only be seen on webpages matching specific Uniform Resource Locator (URL) patterns or using specific desktop apps. Such identifiers can be extracted from the URL, from a page/app title, or from a specific region in the HTML hierarchy of the webpage.

Each website or desktop app where an ID can be extracted is known as a service. By associating observed identifiers together with multiple services, events from multiple services can be associated together under a single case ID. The case ID can originate from whichever service the system determines to be the primary service.

To associate a first identifier with a second identifier, a sequence of events can be defined that represents the observation of identifiers in a particular order, within a bounded time-frame. The system can use this defined sequence of events to link events and their respective identifiers. Such a defined sequence can be a sequence of pages, for example, that are always, or nearly always, visited, in order and in a time pattern, when a new case is originated and handled by a customer service agent. Whenever a linked identifier is determined, that event and any subsequent events are associated with the case as identified by the identifier from the primary service.

In a working example, consider a customer service agent that engages in multiple simultaneous chats and uses a separate CRM service to look up customers and make changes to their accounts. Since the customer service agent switches between the chat windows and the CRM service, there is a need to know, specifically, how much time is spent on each customer and case. The following sequence of events can be defined.

First, the customer service agent receives a new chat box, for example, entitled “Chat 123” on a website that is considered as the primary service. The new Chat ID 123 is created, and the Case ID is marked with the Chat ID. Second, within a threshold time period (e.g., 60 seconds), the customer service agent searches the CRM system for the customer.

Third, within another 60 seconds, the customer service agent lands on the customer's page within the CRM that matches the URL pattern (for example, crm.site.com/customers/234). The CRM ID 234 is recognized, and the ID 234 is linked with Case ID 123.

Fourth, the customer service agent responds to another customer and enters a chat box, for example, with Chat ID 567. This action and subsequent actions in this chat box are not associated events with Chat 123, but instead are associated with Chat 567.

Fifth, the customer service agent goes back to the CRM system on page crm.site.com/customers/234. This surfaces CRM 234 which is linked with Chat 123, associating that event and subsequent events with case 123 until the next time case 123 is interrupted.

Note that, if the customer service agent performs other events at the same time as the sequence of events described above, such additional events do not affect the system's ability to recognize system operation. This is because certain implementations do not require that the set of events is exclusively limited to the chat and CRM events noted above.

In some implementations, the functionality of the techniques of the present disclosure can be represented in pseudocode. Assume that event stream is a variable that represents a time-ordered list of the following types of events: 1) webpage visits with URLs and page titles, 2) desktop application window events with page titles, and 3) clicks, events, and interactions within a web page on a particular webpage element or region that has its own descriptors. A case ID can be defined as any identifier associated with a service that is the primary tool used for customer communications. In such a case, pseudocode describing operation of the workforce analytics manager of FIG. 1A can include:
identifier_mappings =<Mapping of Case ID to list of linked identifiers>
all_possible_sequences =<List of event sequences already in process for each rules pertaining to possible sequences of events>
current_case_id = None

```
for event in event_stream:
  for current_sequence_step in all_possible_sequences:
    if current_sequence_step.matches(event):
      identifiers = current_sequence_step.get_identifiers(
        event.page_title,
        event, url,
        event.html
      )
      current_sequence_step.move_to_next_step( )
      current_case_id = current_sequence_step.get_case_id( )
      # If current_case_id cannot be resolved this way look
      # for a mapping
      If not current_case_id:
      current_case_id = [
        key for (key, existing_identifiers) in identifier_mappings
        if identifiers intersects existing_identifiers
      ]
      if current_case_id:
      identifier_mappings[current_case_id].append(identifiers)
  event.case_id = current_case_id (attribute event to Case ID)
```

At a high level, the pseudocode links events (e.g., customer service agent actions) to corresponding cases and captures event information (e.g., clicks, customer service agent inputs) for the events, e.g., by stepping through a sequence of events that have occurred. Once the system has analyzed agent events and assigned those events to various cases, the system can provide a variety of useful functions. For example, FIG. 3 is a screen shot of an example of a search analytics page 300 for looking up customer service agent events, according to some implementations of the present disclosure. The search analytics page 300 includes search controls that facilitate searching for particular types of customer service agent data, for example, for actions and events by one or more specific customer service agents. The filters can be used to select customer service agent events by combinations of customer service agent name, case type, and case ID. Sorting controls can allow a user of the search analytics page 300 to sort the output of filtered information in different ways.

The search analytics page 300 displays data stream information that can be collected to identify how customer service agents are spending their time on particular cases. The information that is displayed can include case type (for example, printer fires) or specific application (for example, ZENDESK).

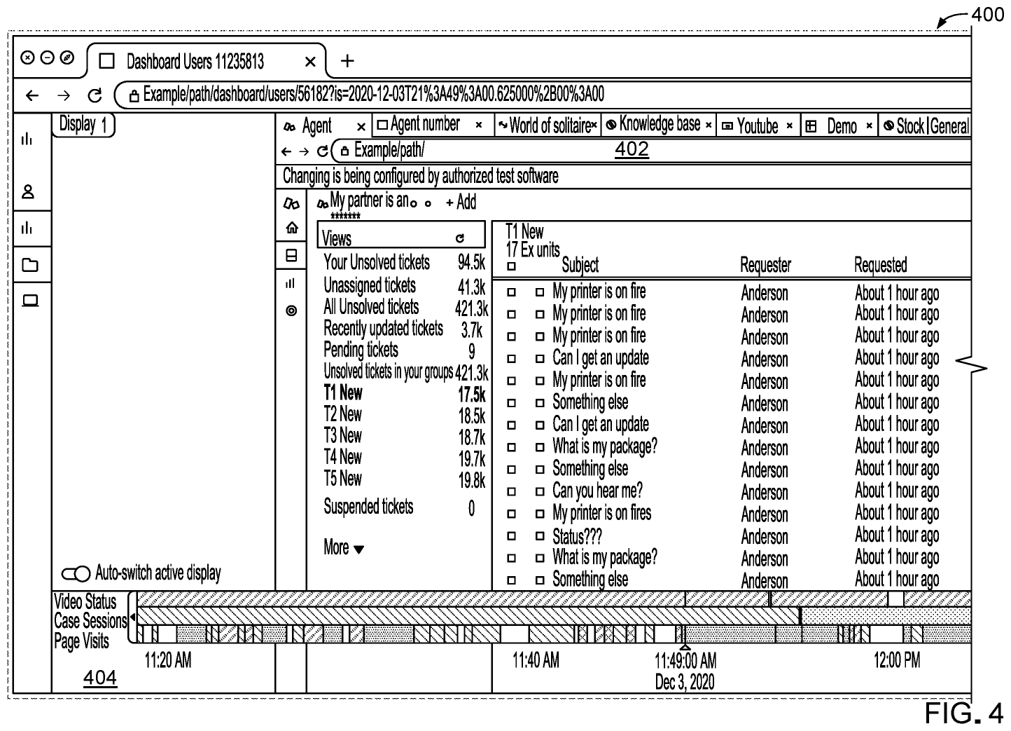

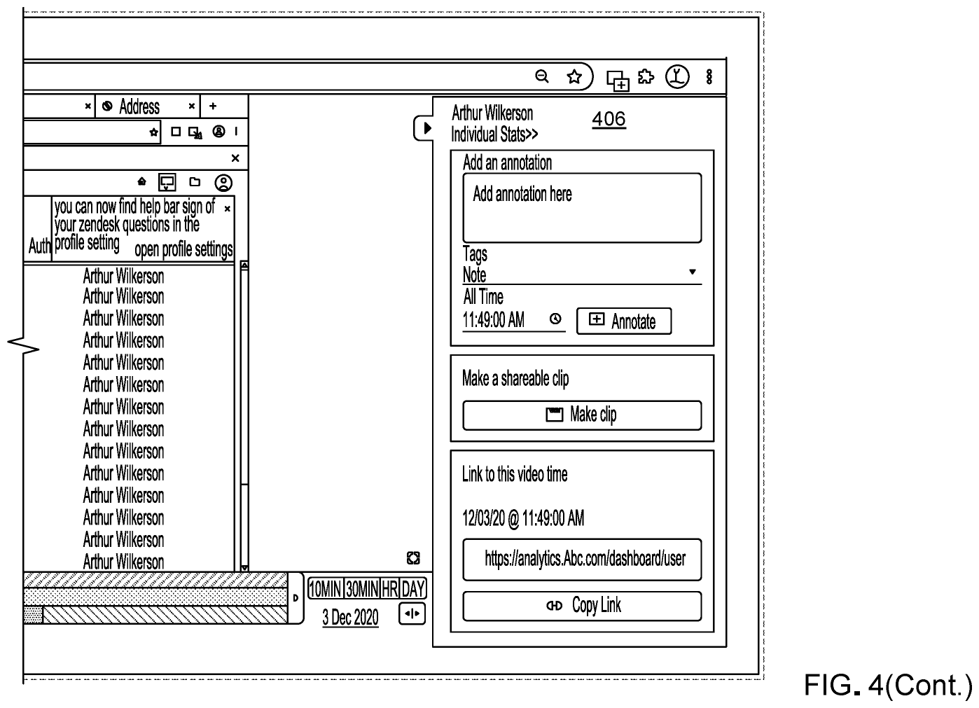

FIG. 4 is a screen shot of an example of a dashboard 400 for customer service agent time spent on cases, according to some implementations of the present disclosure. A cases information area 402 can list different cases, each case's case type (e.g., “My printer is on fire”), and other information for each case.

A video playback area 404 can allow the user of the dashboard 400 to open a video corresponding to focus events for a particular case. The case session video playback area 404 can include a video status bar, a case sessions bar, and a page visits bar. Each bar is displayed relative to time, for example, from opening a case until handling of the case is complete.

A video status bar in the dashboard 400 can allow the user to display a video of what has occurred on overlapping cases. For example, playing the video in high speed can show the overlapping case sessions on which a customer service agent has worked. The video can show, for example, that the customer service agent was working on case X, then looking at a different case, then working on case X again.

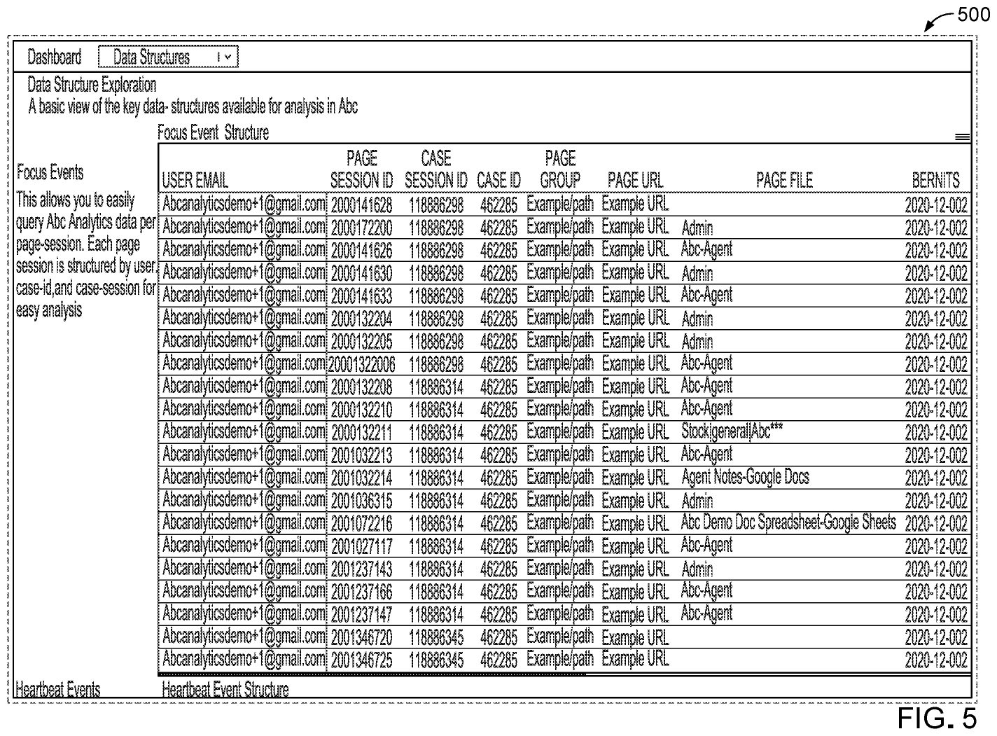

FIG. 5 is a screen shot of an example of a focus events structure 500, according to some implementations of the present disclosure. The focus events structure 500 can be used to capture and store information about page events. This can include information such as every single time the customer service agent switches pages or looks at a new resource, what case is associated, and which case session? The information can include multiple case sessions, the working customer service agent, how much time was spent, page refreshes, key presses, paste actions, and mouse scrolls.

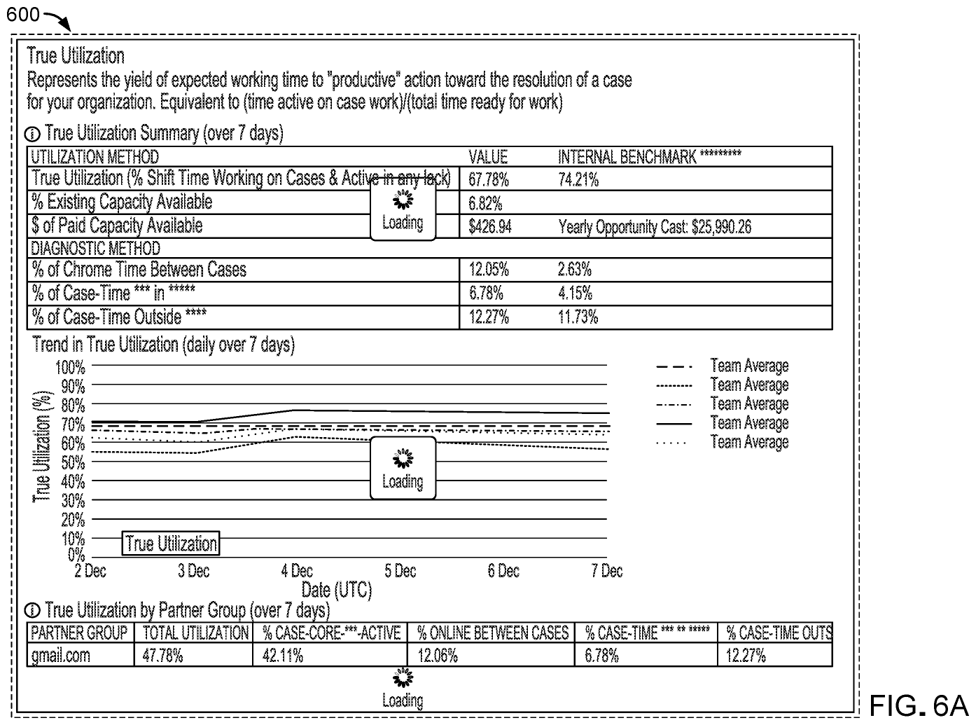

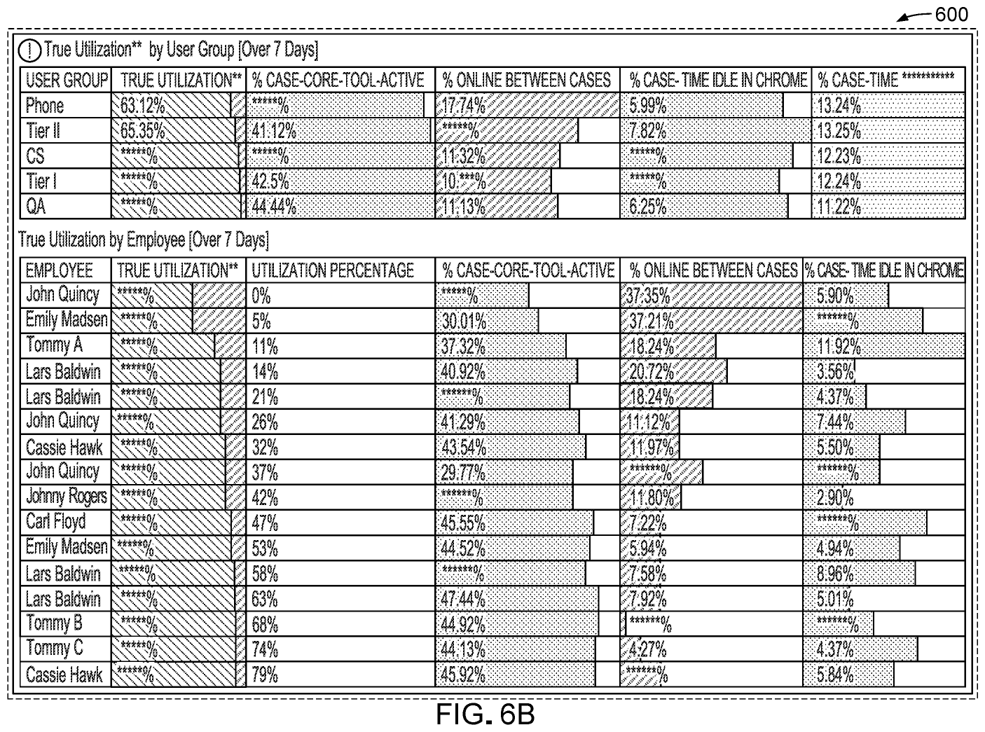

FIGS. 6A-6B are screen shots collectively showing an example of a true utilization page 600, according to some implementations of the present disclosure. The information includes heartbeats indicating, for every 60 seconds, how the CPU is performing, whether the customer service agent was active, page load events, page load times, open tabs, and slow times.

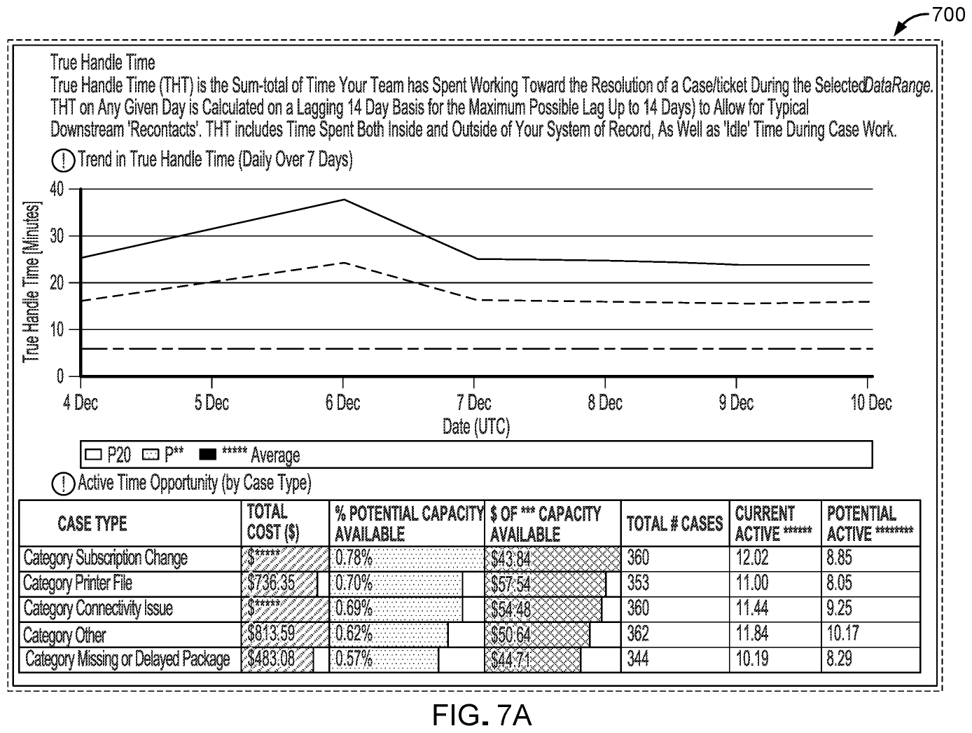

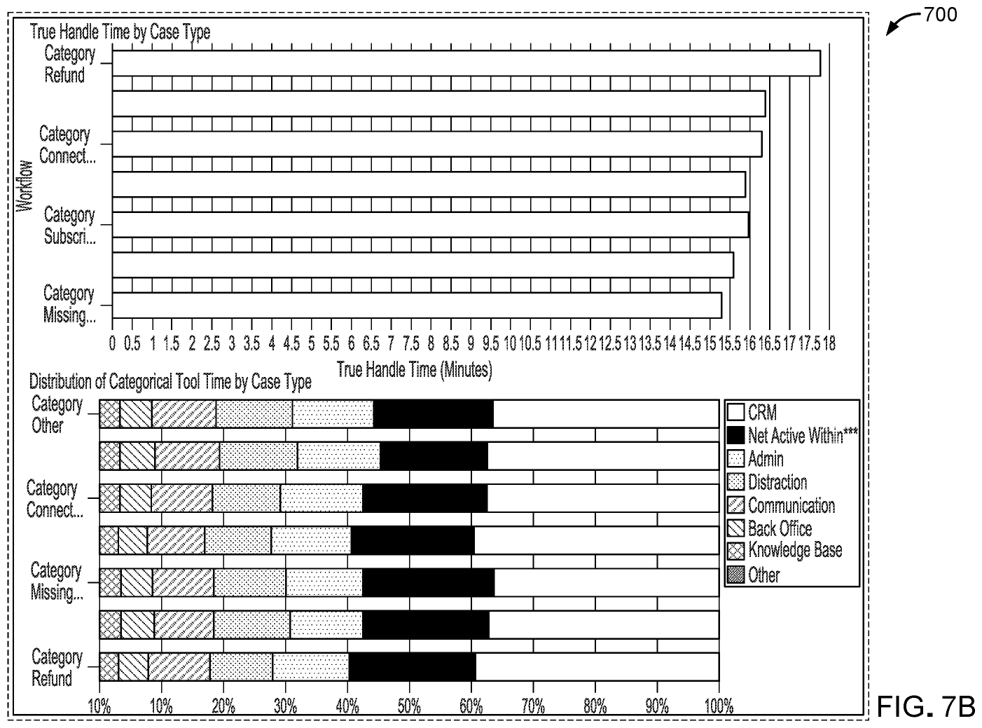

FIGS. 7A-7B are screen shots collectively showing an example of a true handle time page 700, according to some implementations of the present disclosure.

The system uses a Document Object Model (DOM) to monitor clicks, scrolls, and actual IDs of objects accessed, down to the class names. The DOM is a cross-platform and language-independent interface that treats an XML or HTML document as a tree structure, where each node is an object representing a part of the document. The DOM represents a document with a logical tree. Each branch of the tree ends in a node, and each node contains objects. DOM methods allow programmatic access to the tree. Nodes can have event handlers attached to them. Once an event is triggered, the event handlers are executed. The DOM information provides tracking of clicks, and the workflow analytics system can attach the tracked clicks and active page events to a corresponding case. This connection of clicks and active page events to a specified case can be used to understand, for each customer service agent, how active they are, and what opportunities exist for improving true handle times for a particular customer service agent.

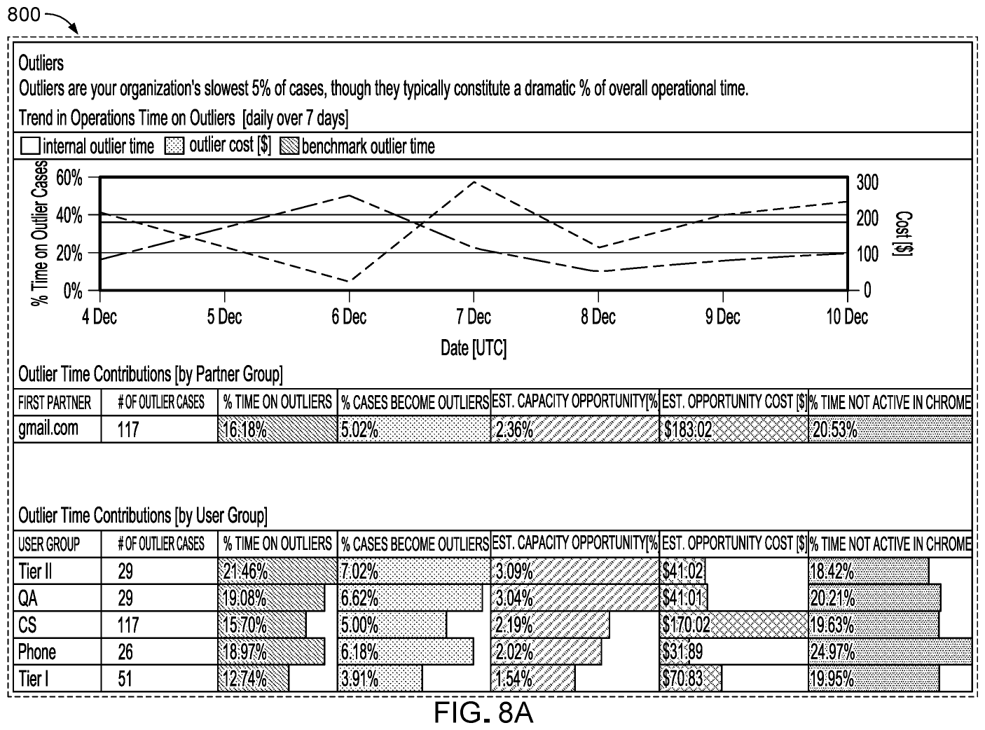

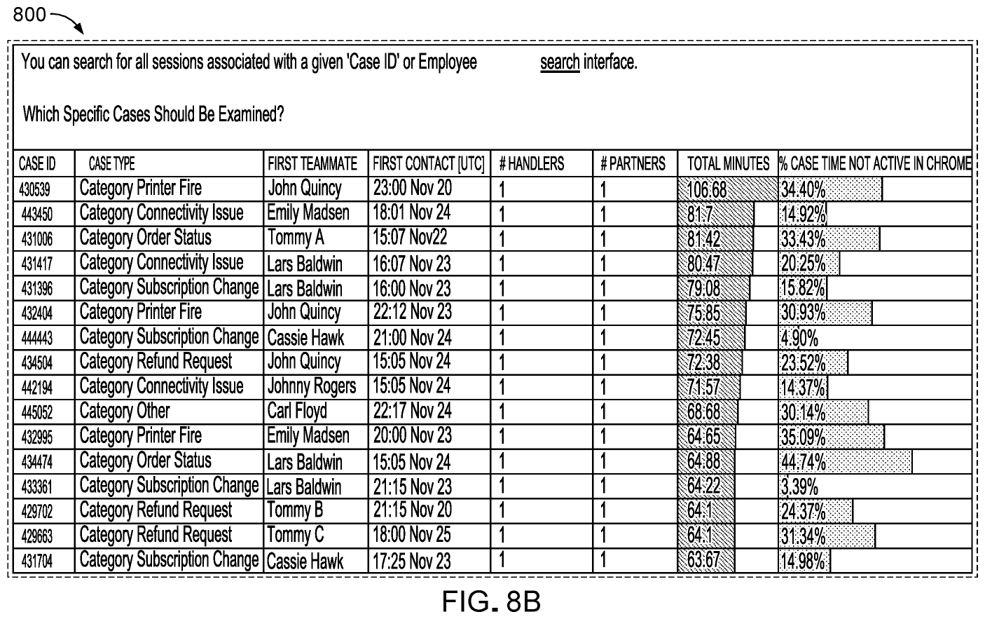

FIGS. 8A-8B are screen shots collectively showing an example of an outliers page 800, according to some implementations of the present disclosure. The outliers can identify the cases that are taking the longest.

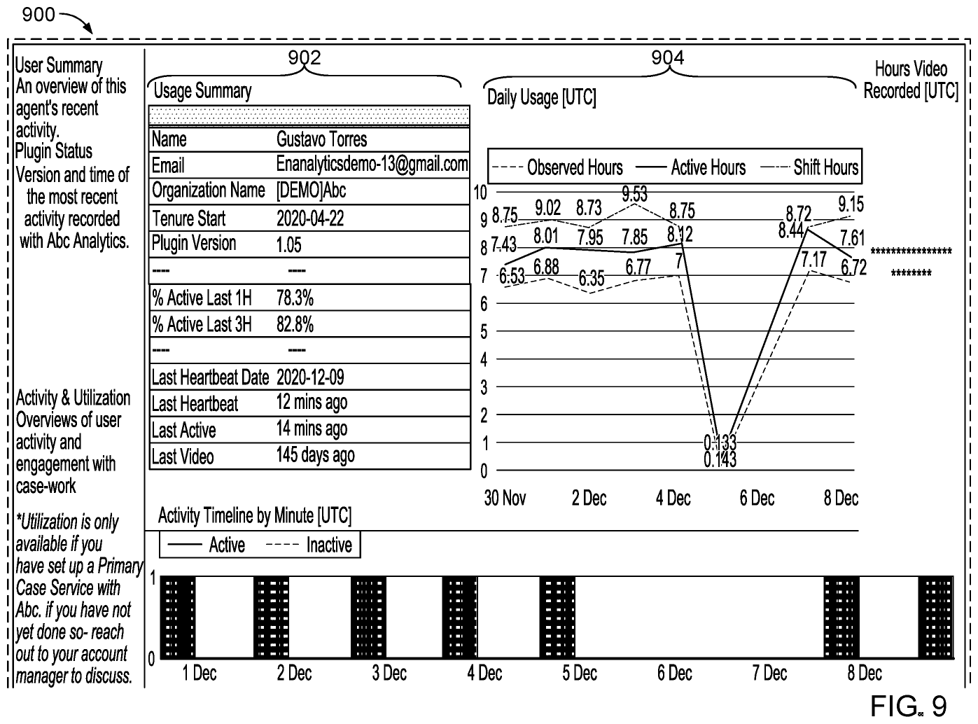

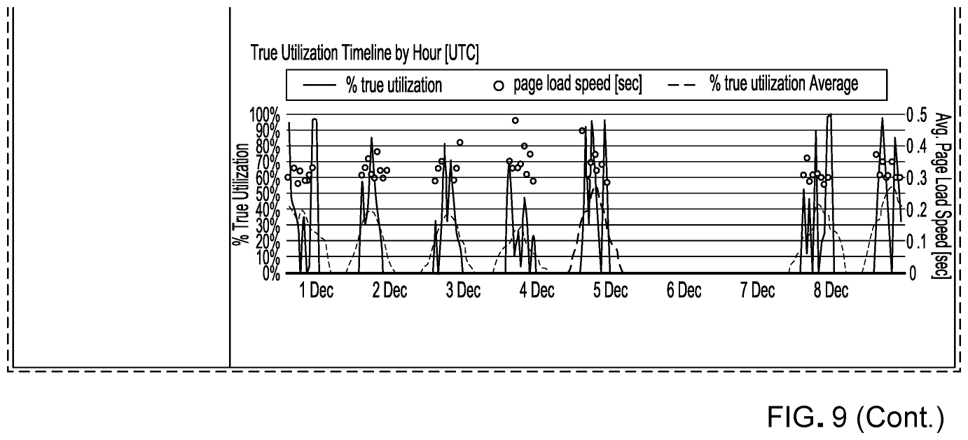

FIG. 9 is a screen shot of an example of a customer service agent summary page 900, according to some implementations of the present disclosure. The customer service agent summary page 900 includes a customer service agent summary area 902 that provides customer service agent profile information and productivity statistics for a customer service agent. A daily usage area 904 includes graphs showing customer service agent activity statistics (e.g., in hours) over time, identifying customer service agent shift hours, observed hours, and active hours.

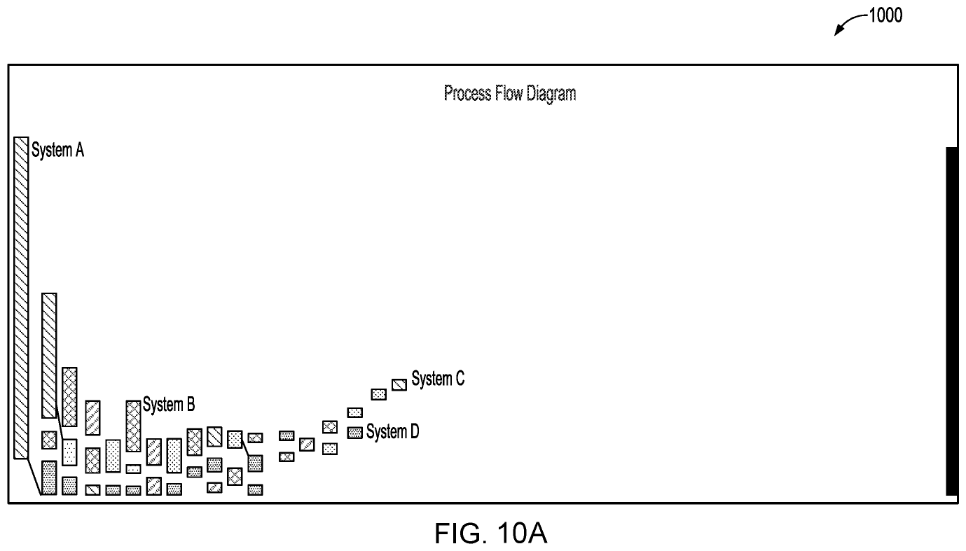

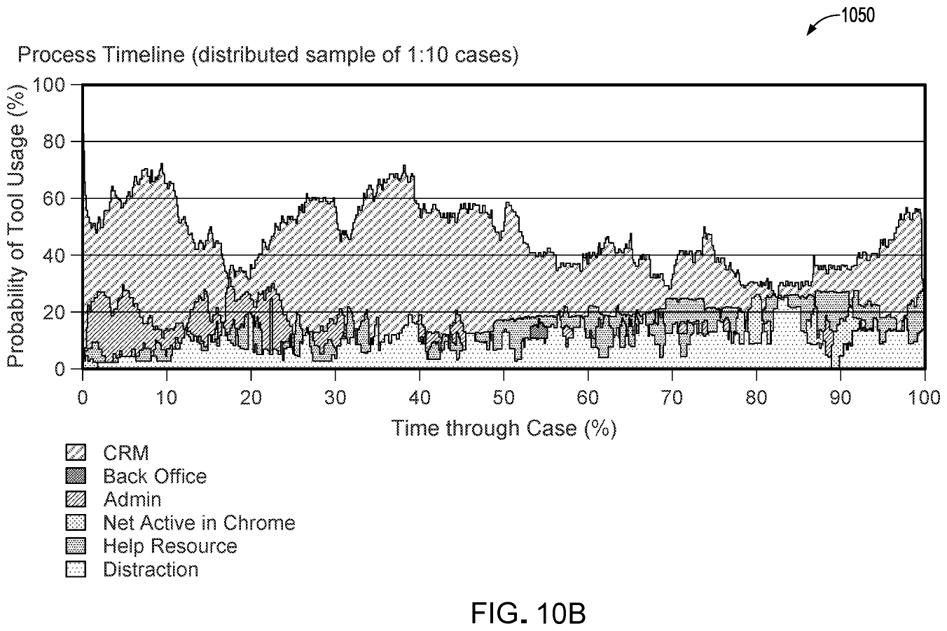

FIG. 10A is a screen shot of an example of a process flow diagram 1000, according to some implementations of the present disclosure. The diagram shows the most likely path to close a ticket based on active page events. Blocks in the diagram are arranged over time and indicate a progression of systems used by the customer service agent to work on the ticket. The blocks can be annotated with one or more of descriptive labels, shading, and color, for example, to indicate that the ticket started in CRM, moved to an administration (admin) tool, and then back to CRM.

FIG. 10B is a screen shot of an example of a process timeline 1050, according to some implementations of the present disclosure. The timeline can show the resources that were used and which ones were used a higher percentage of the time. This can identify where customer service agents are getting stuck and what is likely their next step.

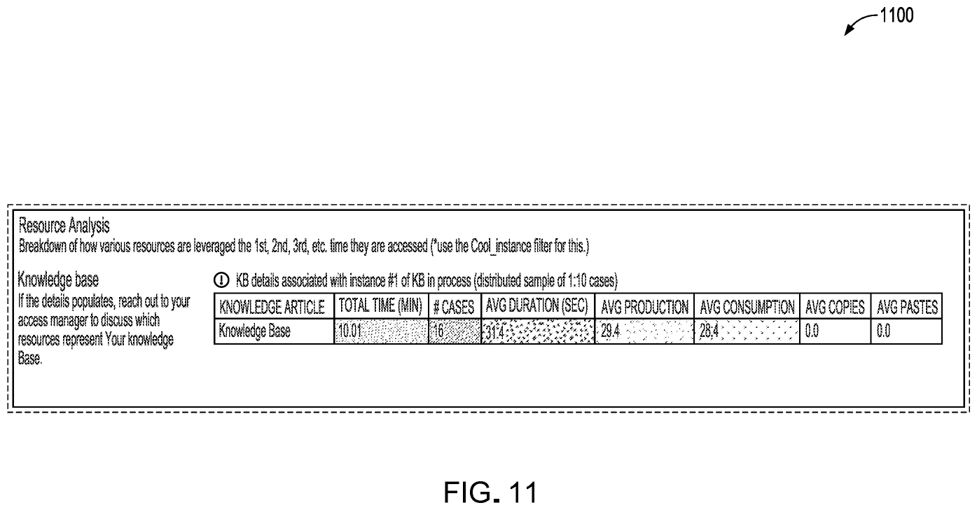

FIG. 11 is a screen shot of an example of a resource analysis page 1100, according to some implementations of the present disclosure.

FIG. 12 is a screen shot of an example of a trigger event definition page 1200, according to some implementations of the present disclosure. Trigger events effectively provide the ability to parse pages visited by a customer service agent while working on a given case. A trigger event can be used to parse the URL, for example, when a page matches XYZ, to extract the case ID out of it. This information can be used to identify how a new case is started. For example, a trigger condition can be set when the URL of a page (e.g., viewed by the customer service agent) matches a particular URL pattern, or when the title of the page matches a particular title pattern. Conditions defined on the trigger event definition page 1200 can be defined using Boolean operators for matches of URLS, titles, and HTML elements found on the page.

As an example, a trigger event can be defined for triggering a new case (or being associated with a current case) when a customer service agent navigates to a web page such as page 208a, having a specific URL. The page 208a can correspond to the first block in FIG. 10A, for example. Using defined trigger events a sequence of events can be tracked that occur in multiple software services being accessed by a customer service agent. The sequence of events can include one or more events from each case of a group of cases handled by the customer service agent. Using information extracted from one or more interactions of the customer service agent with at least one service, focus events can be determined that identify which case in the group of cases is being worked on by the customer service agent at various points in time, with each focus event having a focus event duration. Each focus event can be assigned to a particular case using the extracted information. A total period of time spent by the customer service agent on the particular case can be determined based on a sum of focus events durations for the focus events assigned to the particular case.

In an example, when a trigger (e.g., a page view) occurs, additional controls that are available from the trigger event definition page 1200 can be used to define certain responses that are to happen (or be triggered, in addition to logging the event). The responses can include, for example, creating an activity (e.g., marking this moment, or timestamp, in time), sending an email, sending a workbook, providing a Chrome notification, or redacting video. Marking the moment can cause the moment to be labeled on the timeline of the video playback area 404, for example.

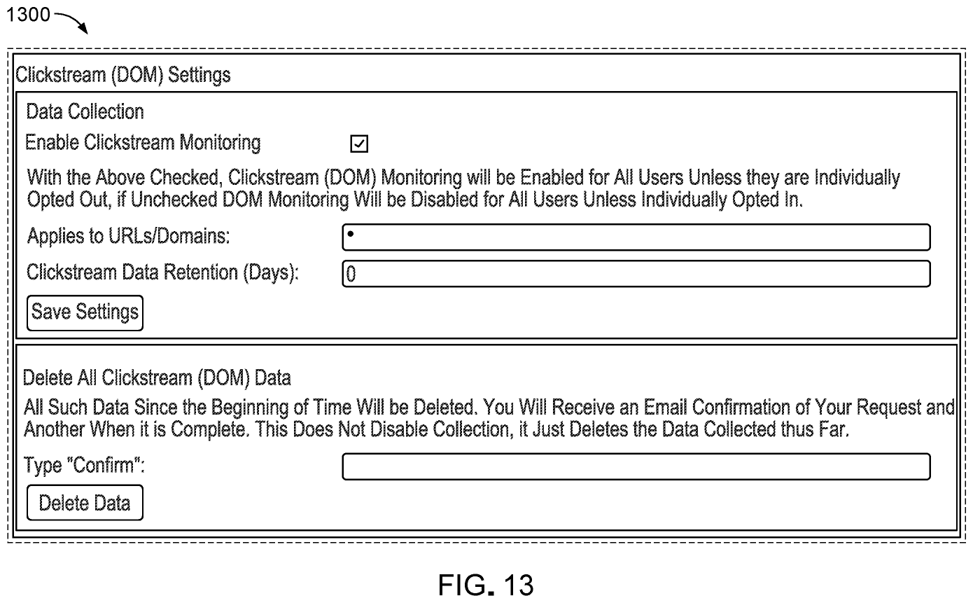

FIG. 13 is a screen shot of an example of a clickstream page 1300, according to some implementations of the present disclosure. The clickstream page 1300 can be used to identify specific data that is to be monitored and collected. Monitoring performed by the clickstream page 1300 can be filtered or limited based on opt-in and opt-out preferences set for specific customer service agents. Settings in the clickstream page 1300 can be used to define specific pages (e.g., by URL) that are to be used in monitoring and to specify a data retention time (e.g., a number of days) for monitored information. Clickstream deletion time fields can be used to control when existing clickstream data is to be deleted.

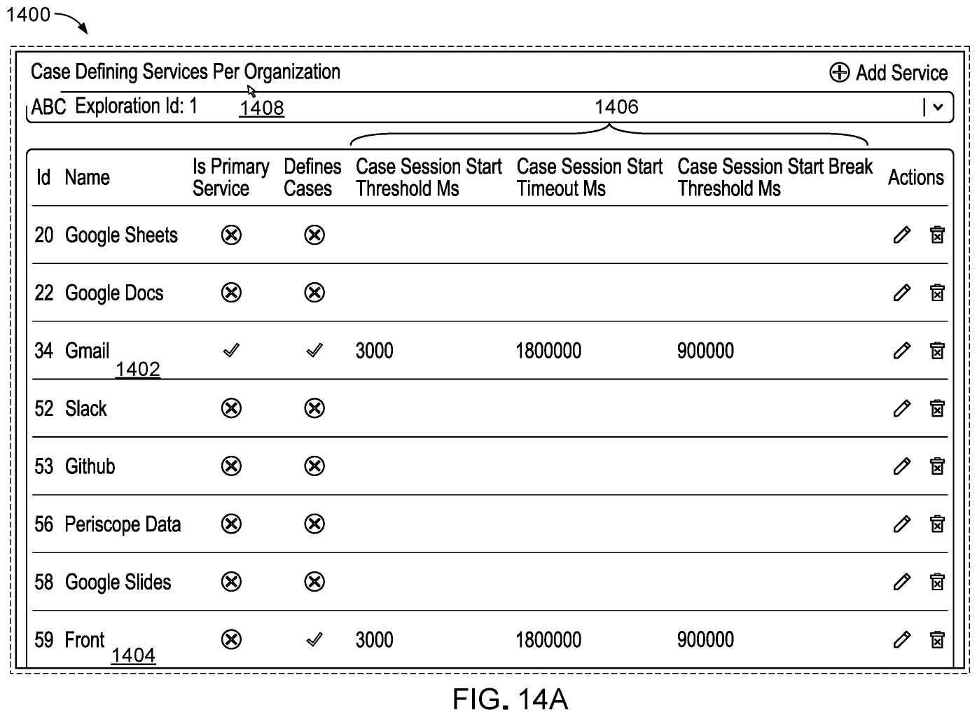

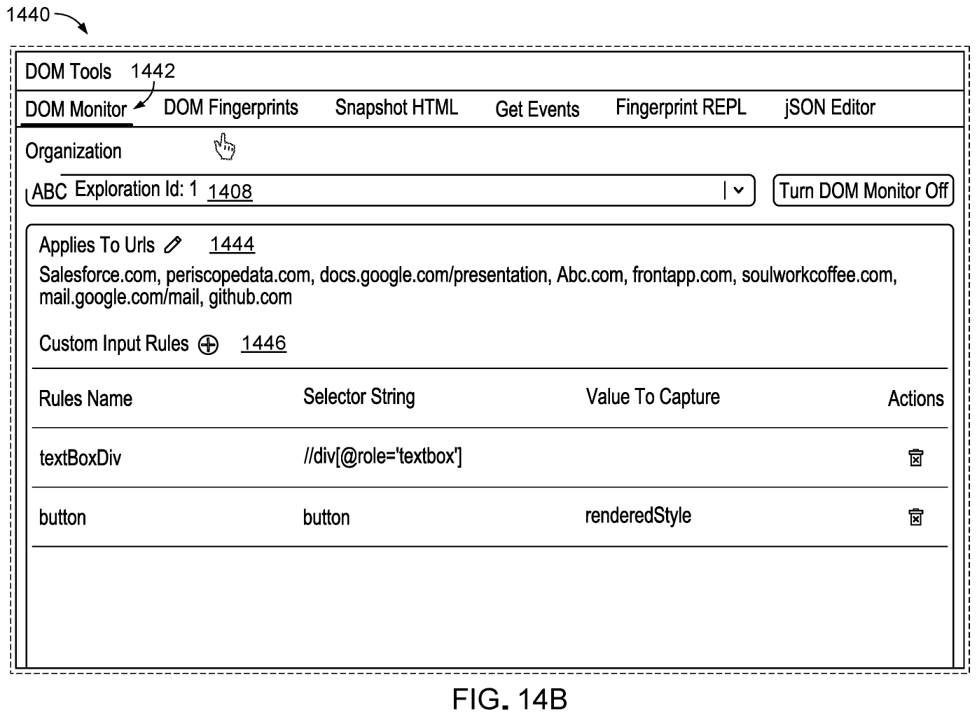

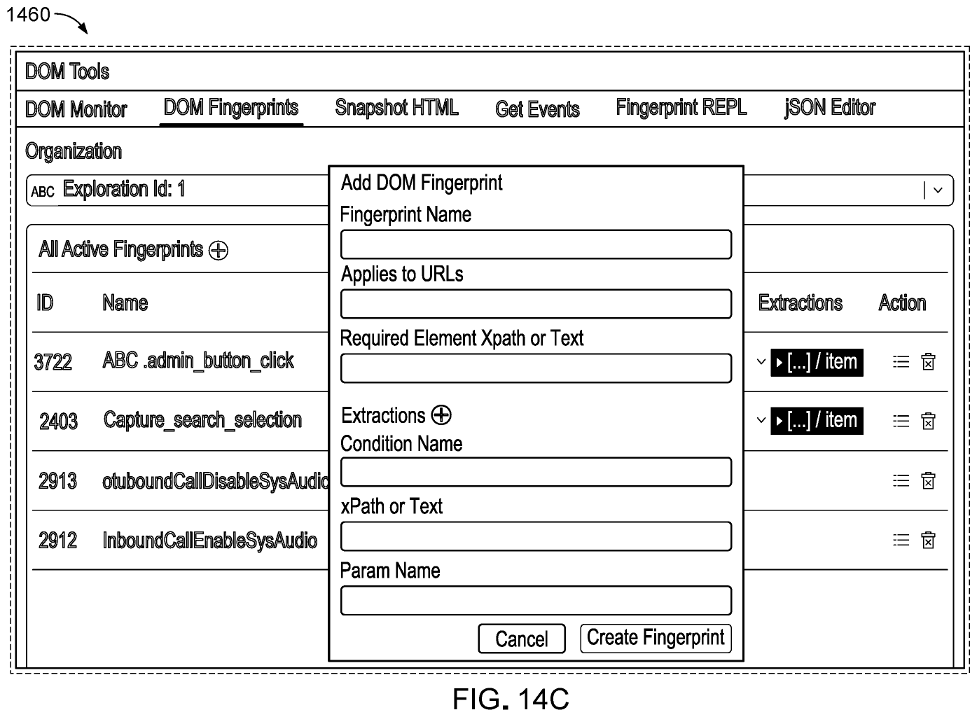

FIG. 14A is a screen shot of an example of a case defining services per organization page 1400, according to some implementations of the present disclosure. The page 1400 allows a user (such as an Administrator of agent monitoring) to identify which services apply to an organization's cases. The definitions identify the names of services and time thresholds (e.g., start, timeout, and break times) that are used to link customer service agent actions to a case. For example, for the case currently defined on the page 1400, fields of the page define a Gmail app 1402 and a Front app 1404, with time thresholds 1406, as being the apps used for cases in Organization ABC 1408. The start time indicates a minimum time that a case is in view before the case is considered being worked on by the customer support agent. Doing this avoids assigning time to a case when the customer support agent tabs through information for the case for only a moment.

FIG. 14B is a screen shot showing an example of a DOM tools page 1440, according to some implementations of the present disclosure. For a currently-selected DOM monitor option 1442, a URLs list 1444 identifies the current list of URLs that DOM settings apply to for the organization 1408. A rules section 1446 facilitates the definition of rules associated with DOM monitoring, including write a rule, for example, that defines a path of an element that starts or ends a specific case.

FIG. 14C is a screen shot showing an example of an add DOM fingerprint page 1460, according to some implementations of the present disclosure. The DOM fingerprint page provides the ability to define a fingerprint that effectively captures the path of an element effectively starting and/or ending a specific case. The fingerprint can apply, for example, to a key press, entry in a field, starting a recording, or some other action.

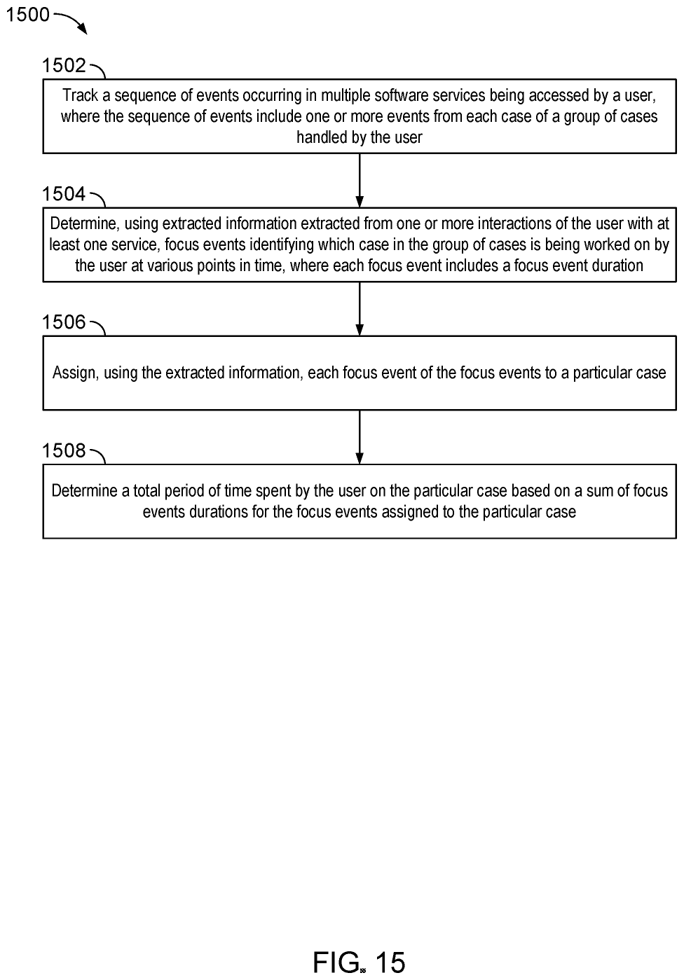

FIG. 15 is a flowchart of an example of a method 1500l for determining time spent by the customer service agent on the particular case, according to some implementations of the present disclosure. For example, the system 200 can be used to perform the method 1500. For clarity of presentation, the description that follows generally describes method 1500 in the context of the other figures in this description. However, it will be understood that method 1500 can be performed, for example, by any suitable system, environment, software, and hardware, or a combination of systems, environments, software, and hardware, as appropriate. In some implementations, various steps of method 1500 can be run in parallel, in combination, in loops, or in any order.

At 1502, a sequence of events occurring in multiple software services being accessed by a user (e.g., a customer service agent) is tracked. The multiple software services can include web pages, documents, spreadsheets, workflows, desktop applications, and conversations on communication devices. As an example, the multiple software services can include web pages used by the user within a CRM system, and the user can be a customer service representative. The sequence of events includes one or more events from each case of a group of cases handled by the user. For example, tracking the sequence of events can include the following. In some implementations, the multiple software services can include at least a software service of a first type and a software service of a second type, where the first type is CRM software and the second type is a search engine.

Focus events are recorded that identify page switches by the customer service agent, views of a new resource by the customer service agent, where each focus event identifies the customer service agent, an associated case, an associated session, a time spent on a particular page, whether the particular page was refreshed, keys that were pressed, copy-paste actions that were taken, and mouse scrolls that occurred. Heartbeats are recorded at a threshold heartbeat interval (for example, once every 60 seconds). The heartbeats can indicate CPU performance and whether the customer service agent has been active (and to what degree). Page load events are recorded including identifying a time to process a page load request, a time to finish loading the page, a number of tabs that are open, and whether a page load was slow. DOM events are recorded, including clicks by the customer service agent, scrolling by the customer service agent, an identifier of a software service, a class name and a subclass name of the software service, and content of text typed into the software service.

In some implementations, tracking the sequence of events can include setting identifier threshold rules defining a set of identifiers used in a set of systems that are to be tracked, disregarding identifiers not included in a tracked subset of the multiple software services, recording timestamps for start and end times on a particular software service, and disregarding, using the start and end times, identifiers corresponding to events that last less than a threshold event duration.

In some implementations, tracking the sequence of events can include collecting active page events, page level events, machine heartbeats, DOM events, video, audio, times when the customer service agent is speaking versus not speaking, times when the customer service agent is using video, entries written to documents, desktop application events, and entries extracted from the documents. From 1502, method 1500 proceeds to 1504.

At 1504, focus events identifying which case in the group of cases is being worked on by the customer service agent at various points in time are determined using information extracted from one or more interactions of the customer service agent with at least one service, where each focus event includes a focus event duration. From 1504,method 1500 proceeds to 1506.

At 1506, each focus event of the focus events is assigned to a particular case using the extracted information. For example, assigning each focus event of the focus events to a particular case can include linking previously unlinked identifiers from the software services by observing an expected behavioral pattern for using the multiple software services in a particular order pattern to respond to and close the particular case. In some implementations, the expected behavioral pattern can be company-dependent. In some implementations, the expected behavioral pattern can include ICIs including a timeframe defining an amount of time between a start time of the particular case and a next step performed by the customer service agent on the particular case. From 1506, method 1500 proceeds to 1508.

At 1508, a total period of time spent by the customer service agent on the particular case is determined based on a sum of focus event durations for the focus events assigned to the particular case. As an example, assigning a focus event to the particular case can include using clustering algorithms to identify and cluster a same customer corresponding to the particular case across the multiple software services. After 1508, method 1500 can stop.

FIG. 16 is a block diagram illustrating an environment 1600 that includes a true utilization engine 1601. The true utilization engine 1601 can be a part of the workforce analytics manager 101,for example. As described above, support representatives, such as a support representative 1602, can provide support for users, such as a user 1604. The support representative 1602 can perform support interactions using a computing device 1606 and/or other devices(s). The user 1604 can contact a support system using a device 1608, which may be a smartphone as illustrated (e.g., using a voice call and/or browser or application connection) or some other type of device.

The true utilization engine 1601 (or another system) can retrieve interaction information 1610 that describes interactions that occur during various support cases for the support representative 1602 for a particular time period (e.g., day, week, month). The true utilization engine 1601can also obtain timing data for the support representative 1602 that indicates available work time for the support representative 1602 during the time period.

A productivity rules evaluator 1612 can evaluate productivity rules 1614 that have been defined or configured for an organization of the support representative 1602 (or in some cases learned by a machine learning engine, as described in more detail below). The productivity rules 1614 can include conditions defining productivity of interactions by users of the organization. The productivity rule evaluator 1612 can evaluate the productivity rules 1614 with respect to the interaction information 1610 for the support representative 1602 to determining productivity of the interactions taken by the support representative 1602 during the time period.

A true utilization determination engine 1616 can determine true utilization for the support representative 1602 based on the productivity of the interactions and the available work time for the support representative 1602 during the time period. For example, the true utilization determination engine 1616 can determine true utilization by determining a sum of productive time and dividing the sum of productive time by the available work time. A true utilization presentation component 1618 can present true utilization information, such as to a supervisor 1620 on a supervisor device 1622. As described in more detail below, other outputs can be produced and other actions can be taken, by the true utilization engine 1601 or by other system(s), based on determined true utilization information.

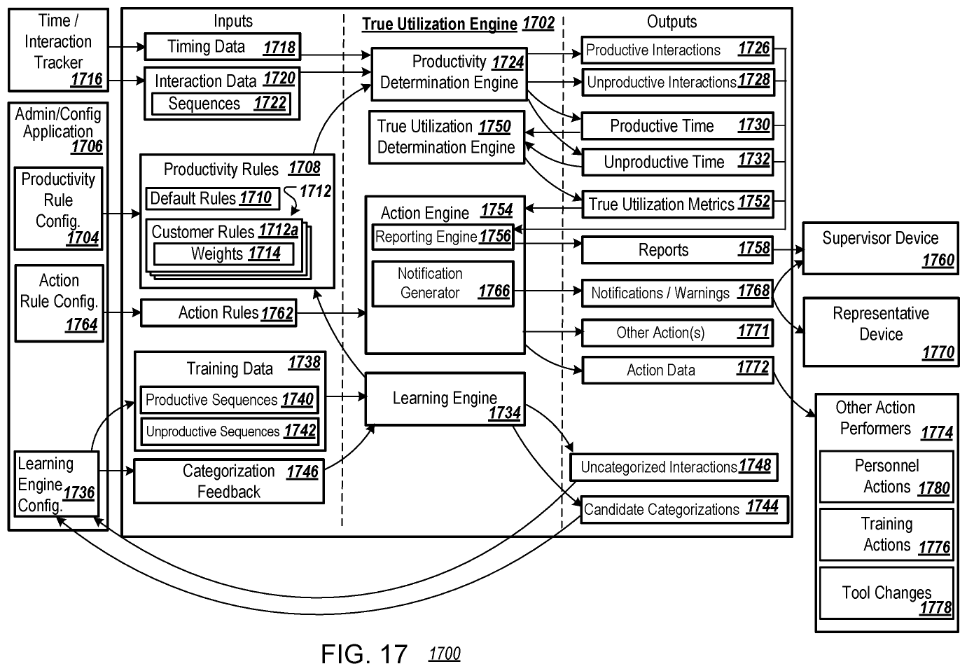

FIG. 17 is a diagram of the components of an exemplary system 1700 for determining true utilization based on productive behaviors of operators in a digital environment. The system 1700 includes a true utilization engine 1702. As described in more detail below, productivity rules used by the true utilization engine 1702 can be specified or defined using a productivity rule configuration portion 1704 of an administrative/configuration application 1706. For example, an administrator of the true utilization engine 1702 and/or an administrator for a particular customer may define productivity rules 1708 that are provided as input(s) to the true utilization engine 1702. In some implementations, the administrator of the true utilization engine 1702 can define default productivity rules 1710 that can be used (after possibly being customized) by different customers. As another example, a customer administrator and/or the administrator of the true utilization engine 1702 can define customer-specific productivity rules 1712 that are specific to and used by specific customers. For example, particular customer-specific productivity rules 1712a may be only used by one particular customer.

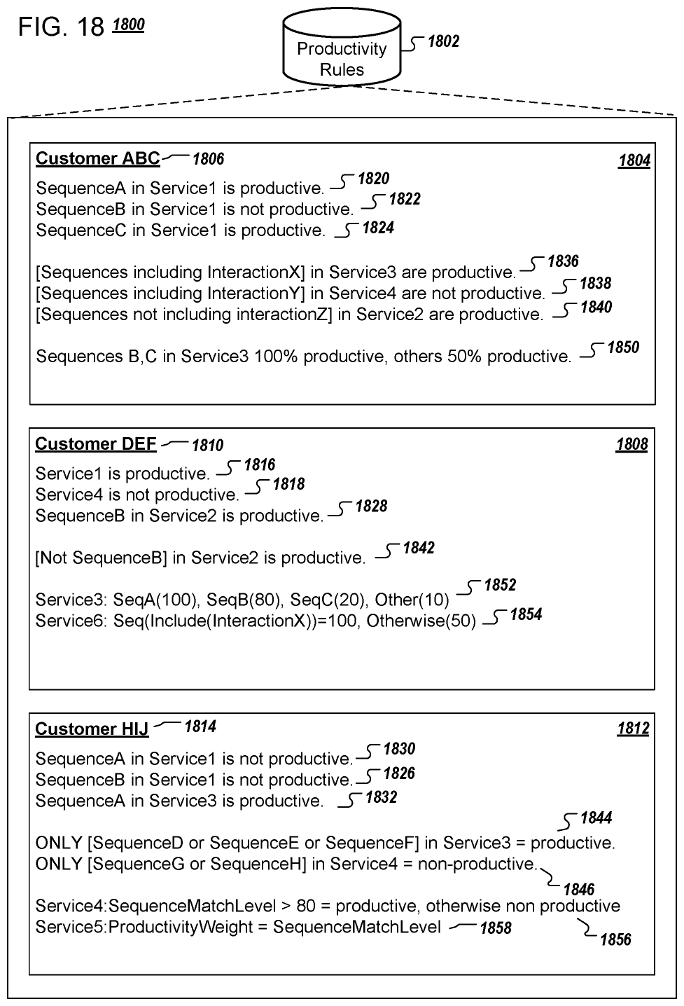

In general, the productivity rules 1708 specify condition(s) for which representative interactions or sequences of interactions are productive or non-productive. The productivity rules 1702 can describe patterns of productive (or non-productive) behavior, for example. Although some rules may define which behaviors are productive or non-productive as a binary classification, other rules can describe a degree of productivity. For example, the customer-specific productivity rules 1712a include weights 1714 that can be applied to classify certain behaviors as partially productive. Weights are described in more detail below with respect to FIG. 18.

For each customer, a time/interaction tracker 1716 can track representative interactions and activity to produce timing data 1718 and interaction data 1720. The time/interaction tracker 1716 can be or include software on representative computing devices that logs operator time available with the digital workspace of the representative. The timing data 1718 can include representative time available for work and durations of tracked interactions. The time/interaction tracker 1716 can track and log representative/operator behavior such as typing, mouse movements, item selections, etc., including selections of objects, to generate the interaction data 1720. The interaction data 1720 can also include information describing sequences of interactions 1722.

The timing data 1718, the interaction data 1720, and the productivity rules 1708 can be provided to a productivity determination engine 1724 included in the true utilization engine 1702. The productivity determination engine 1724 can determine (e.g., based on the timing data 1718, the interaction data 1720, and the productivity rules 1708), productive interactions 1726, unproductive interactions 1728, productive time 1730 (e.g., out of available time), and unproductive time 1732. The productivity determination engine 1724 can apply the productivity rules 1708 to the interaction data 1720, for example, to match interactions in the interaction data 1720 to productivity rules 1708 that define productive and/or nonproductive behavior.

The productivity determination engine 1724 can determine the productive time 1730 by determining a net yield of productive time spent by the representative. Although productivity rules are defined, in some cases, instead of or in addition to rules for productivity or non-productivity, other rules can be defined that specify conditions for other classification buckets to which interactions, sequences, or work time can be attributed. In addition or alternatively to determining the productive interactions 1726 and the unproductive interactions 1728 using prescribed indicators reflected by the productivity rules 1708, the productivity determination engine 1724 can be included in, used, or otherwise be associated with a learning engine 1734 that can determine productivity using learned model(s).

The productivity determination engine 1724 can be configured to perform multiple, parallel assessments of productivity, to increase an efficiency of productivity determination. For example, the productivity determination engine 1724 can evaluate different productivity rules 1708 simultaneously, in different processes or threads. Output from multiple parallel processes can be evaluated as a final step, to aggregate outputs of evaluating different productivity rules 1708.

The learning engine 1734 can be trained using ground truth in a variety of ways. For example, an administrator can use a learning engine configuration application 1736 to provide ground truth training data 1738 to the learning engine 1734. The ground truth training data 1738 can include known productive sequences of interactions 1740 (or known productive interactions) and known unproductive sequences of interactions 1742 (or known unproductive interactions).

One example machine learning approach can include using a random forest approach to assign a probability of productivity/utilization for a given event or sequence. Input features can include whether the event or sequence occurred during scheduled work hours, a time offset from a last seen unit of work (e.g., +2300 milliseconds), a classification of an interacting resource (e.g., “core,” “assistive,” “communication,” “distraction,” etc.) A classification of an interacting resource may be made by other classification model(s) that evaluate and classify all resources the operator interacts with, or may be predetermined by the customer. Other features may include a nature of Interaction (e.g., duration, mouse click, keystroke, mouse move, sequence progress, etc.) or a value of value of interaction (e.g., 10 ms, 3 clicks, 57 keypresses, 100 pixels, 60% of sequence completed, etc.). For training input data, an input parameter can be an indication whether the training data corresponds to productive or unproductive activity. Hyperparameters of the machine learning approach can include a regression type (e.g., MSE (Mean Squared Error)), a sample with replacement setting, an initial depth (e.g., ten), a number of features (e.g., an initial feature count may be four), a number of estimators (e.g., an initial estimator count may be five hundred), a number of samples to leave (e.g., starting with one), and a number of samples to split (e.g., starting with two).

The learning engine configuration application 1736 can include a user interface that can enable an administrator to inspect specific focus events or event sequences and to define (e.g., as productive sequences 1740 or unproductive sequences 1742), a designation of productivity or utilization for a given event or sequence, for training or re-training the learning engine 1734. The learning engine configuration application 1736 can also be used to designate attributes of focus events and/or event sequences as features for the machine learning model used by the learning engine 1734. Features, as mentioned, can include duration, count of keypresses of focus events, etc., and can be used as machine learning features in combination with the event or sequence productivity designation to affect future machine learning.

In a testing phase, the learning engine 1734, once trained, can generate candidate categorizations 1744 of productive/nonproductive interactions and/or sequences which can be provided to a user (e.g., test, administrator) in the learning engine configuration application 1736. The user can provide feedback 1746 on the candidate categorizations 1744, with the feedback 1746 being used to further train the learning engine 1734.

Regarding the training data 1738, in some cases, some sequences may be known to be productive and other sequences that don't match the known productive sequences may be initially assumed to be non-productive. Similarly, some sequences may be known to be unproductive and other sequences that don't match the known unproductive sequences may be initially considered as productive.

In some cases, the learning engine 1734, either during testing or post-testing use, outputs uncategorized interactions 1748 (e.g., interactions or sequences for which the learning engine 1734 isn't able to generate a productivity categorization or score with at least a certain level of confidence). The uncategorized interactions 1748 can be provided to a user in the learning engine configuration application 1736, with the user providing feedback 1746 regarding the uncategorized interactions 1748 and the learning engine 1734 being further updated with improved learning model(s) based on the feedback 1746.

Once trained and tested, the learning engine 1734 can identify representative actions that are productive based on learning models. In some cases, the productivity determination engine 1724 generates a first set of productivity scores or weights for interactions, based on prescribed productivity rules 1708 and the learning engine 1734 generates separate productivity scores or weights, using learned models. An overall combined productivity score or weight for an interaction or sequence can be determined based on respective scores from the productivity determination engine 1724 and the learning engine 1734. For example, an average score can be determined, or weighted scores can be factored into the overall score based on a confidence score (e.g., produced by the learning engine 1734) or a match score (e.g., produced by the productivity determination engine 1724).

Information regarding productive time 1730 and unproductive time 1732 can be provided to a true utilization determination engine 1750. The true utilization determination engine 1750 can determine true utilization metrics 1752 based on the productive time 1730 and unproductive time 1732 information. The true utilization metrics 1752 can represent, for one or more representatives, a net yield of productive time spent by the representative, for example as a fraction of the representative's time available for work. The true utilization determination engine 1750 can, for example, calculate a true utilization metric 1752 for a representative by dividing a sum of representative time spent on productive work by a sum of representative time available within a digital workspace. True utilization metrics 1752 can be calculated for all representatives observed within a particular time range (e.g., day, week, month, year).

The true utilization metrics 1752 can be provided to an action engine 1754 and the action engine 1754 can generate action data and/or perform one or more actions based on the true utilization metrics 1752. For example, the true utilization metrics 1752, as well as information about productive interactions 1726, nonproductive interactions 1728, productive time 1730, and unproductive time 1732, can be provided to a reporting engine 1756 for inclusion in one or more reports 1758 generated by the reporting engine 1756. The reports 1758 can be provided to one or more entities, such as for presentation on a supervisor device 1760.

In some implementations, action rules 1762 are configured, for example using an action rule configuration application 1764 (e.g., by a customer or true utilization engine 1702 administrator). Action rules 1762 can specify which action(s) the action engine 1754 is to perform in response to generation of true utilization metrics 1752. Some action rules 1762 may specify that certain actions are to be performed in response to generation of certain types of true utilization metrics 1752. For example, certain reports 1758 may be generated and sent to certain supervisor devices 1760 based on configured supervisor-employee relationships. As another example, action rules 1762 can specify that certain action(s) are to be performed when a true utilization metric 1752 is above or below a threshold. For example, an action rule 1762 can specify that if a true utilization metric 1752 is below a specified threshold that a notification generator 1766 is to generate one or more notifications and/or warnings 1768 which can be provided to specified supervisor devices 1760 and/or to specified representative devices 1770.

Other than reporting and notifications/warnings 1768, in some implementations, the action engine 1754 can perform one or more other actions 1771 based on the true utilization metrics 1752 (and/or based on other productivity-related information). For example, if utilization drops beneath a particular threshold, an operator could be blocked from performing additional work on a current task, and the task can be automatically routed to a next available operator. Such automatic rerouting can be used to help promote more rapid resolution of work, or more focused (and likely higher quality) resolution of work.

In some cases, the action engine 1754 generates action data 1772 which can be provided to one or more other action performers 1774. The action data 1772 can be raw true utilization metrics 1752, related productivity information, or can be filtered or aggregated true utilization or productivity information. For example, action data 1772 can include true utilization and representative information for representatives who have true utilization metrics 1752 above or below certain thresholds. For example, action data 1772 can include information for representatives who have true utilization less than 50%. The action data 1772 can be provided to supervising and/or training entities who can perform one or more training actions 1776, such as adjusting training materials or recommending or scheduling a representative for certain training. Low levels of true utilization across a large pool of tasks or operators can be used to self-identify new work streams which may not have been previously known to an organization. For example, when self-similar patterns of work across a large number of interactions are identified as unproductive, the organization can be alerted that there may an opportunity to discover new processes to categorize, evaluate, and formalize within the workflows of the organization. In some cases action data 1772 can include information about use of certain tools that are known or have been determined to be unproductive. Such action data 1772 can be provided to one or more supervisor entities who may perform one or more tool change actions 1778, such as removing certain tool access or limiting tool use except for authorized uses.

When the action data 1772 includes true utilization and representative information for representatives who have true utilization metrics 1752 above or below certain thresholds, various personnel actions 1780 can be performed, such as promotions, demotions, compensation adjustments, awards, etc. For example, productivity triggers can be used to automate payroll or billable hour accounting or auditing for hourly pay models. For instance, when productivity is detected, billing for operators can start (and potentially only at a net utilization rate), and when productivity stops or goes below a threshold utility rate, corresponding time can be automatically excluded from accounting until an acceptable level of productivity resumes. Accordingly, true utilization tracking can enable precise billing models with clear audit trails.

Other actions and use of true utilization can occur. For example, true utilization information can be used to understand downstream implications of an operator's actions. For instance, if customers of an organization generate lifetime value of $5000 when the operators working on their support requests are at least 80% utilized, but only provide $3000 lifetime value when operators exhibit utilization less than 80%, true utilization information can be used as a leading indicator for customer success, satisfaction, or dissatisfaction, and can trigger preemptive measures to help retain or increase downstream engagement of the customers of the organization.

FIG. 18 is a diagram 1800 that illustrates exemplary productivity rules 1802 for different customers. A server can maintain a productivity rules repository 1802. The server can store, in the productivity rules repository 1802, different productivity rules for different customers. For example, the productivity rules repository 1802 can store productivity rules 1804 for a customer ABC 1806, productivity rules 1808 for a customer DEF 1810, and productivity rules 1812 for a customer HIJ 1814. Although shown as being stored in a same repository, in some implementations, different customer productivity rules are stored in different repositories.

Each productivity rule in the productivity rules 1802 can specify a condition for how productive time is measured for customer service agents of a given customer. Various types of productivity rules can be defined, with different conditions, to enable each customer to define specific productivity rules that are tailored to desires or needs of the particular customer. The server can retrieve and evaluate customer-specific productivity rules, at runtime, to evaluate, for a given customer, whether customer representative time is considered productive.

For a given customer, different productivity rules can be defined for different services. For example: the productivity rules 1804 for the customer ABC 1806 relate to a Service1, a Service2, a Service3, and a Service4; the productivity rules 1808 for the customer DEF 1812 relate to Service1, Service2, Service3, Service4, and a Service6; and the productivity rules 1812 for the customer HIJ 1814 relate to Service1, Service3, Service4, and a Service5.

The productivity rules repository 1802 can store different productivity rules for different customers for a same service. For example, the productivity rules1804, 1808, and 1812 for the customer ABC 1806, the customer DEF 1810, and the customer HIJ 1814, respectively, each include productivity rules for Service1 but with different conditions. Service1 may be a service used by multiple customers, such as email service or a knowledge base service that is available to different customers, but each customer can define what type of use of Service1 is considered productive.

As another example, the productivity rules repository 1802 can store productivity rules for services that are unique to a given customer. For instance, Service6, which is only referenced in the productivity rules 1808 for the customer DEF 1810, may be a service that is only used by the customer DEF 1810 and not other customers. Only the customer DEF 1810 may have Service6 installed and configured for use, for instance. As another example, Service5 is only referenced in the productivity rules 1812 for the customer HIJ 1814. Service5 may be a service developed by the customer HIJ 1814, for instance (and only used by the customer HIJ 1814 and not other customers).

In some cases, productivity rules can specify whether general use of certain services are productive or non-productive. For example, productivity rules 1816 and 1818 for the customer DEF 1810 specify that use of Servicel is productive and use of Service4 is not productive, for customer service agents of the customer DEF 1810, respectively. For more refined productivity rules, for some services and for some (or all) customers, productivity rules can be based on sequences of actions.

For example, productivity rules 1820, 1822, and 1824 for the customer ABC 1806 specify that a SequenceA in Service1 is productive, a SequenceB in Service1 is not productive, and a SequenceC in Service1 is productive, for customer service agents of the customer ABC 1806, respectively. As illustrated by the productivity rules 1820, 1822, and 1824, different productivity rules for different sequences can be defined, for a same service, with some productivity rules defining which sequence(s) of interactions with the service are productive and other productivity rules defining which sequence(s) of interactions with the service are not productive. As another example, a single rule can specify which sequences for a service are productive (and/or non-productive).

In some implementations, different customers may define a same productivity rule or similar productivity rules. As another example, a default productivity rule, currently used by multiple customers, may include a same or similar set of condition(s). In some implementations, a same (or substantially similar) sequence can be used in different productivity rules, for different customers, for a same or different service. For instance, both the productivity rule 1822 for the customer ABC 1806 and a productivity rule 1826 for the customer HIJ 1814 specify that SequenceB in Service1 is not productive. As another example, a productivity rule 1828 for the customer DEF 1810 specifies that SequenceB in Service2 is productive.

In general, different customers may define different or same conditions, for a same sequence and/or a same service. For example, a productivity rule 1830 for the customer HIJ 1814 specifies that SequenceA in servicel is not productive when performed by customer service agents of the customer HIJ 1814. In contrast, for customer ABC 1806, the SequenceA in Service1 is construed as productive.

When defining productivity rules, a same (or similar) sequence may be defined as productive in one service but unproductive in another service. For instance, a customer may instruct and prefer that customer service agents use a particular (e.g., preferred or standard) service rather than an alternative service. For example, a productivity rule 1832 for the customer HIJ 1814 specifies that SequenceA is productive in Service3, in contrast to SequenceA being identified, in the productivity rule 1830, as unproductive, for customer service agents of the customer HIJ 1814. As another example, a productivity rule could be added to the productivity rules 1812 that specifies that all use of the Servicel is unproductive for customer service agents of the customer HIJ 1814.

Different types of rule conditions, different complexities of rule conditions, and various types of syntax or approaches for defining rule conditions can be used. For example, a productivity rule 1836 for the customer ABC 1806 specifies that interaction sequences for Service3 that include “InteractionX” are productive. A productivity rule 1838 specifies that interaction sequences for Service4 that include “InteractionY” are not productive. A productivity rule 1840 specifies that interaction sequences for Service2 that do not include “InteractionZ” are productive.

As another example, a productivity rule 1842 for the customer DEF 1810 specifies that sequences of interactions in Service2 other than SequenceB are productive. As yet another example, a productivity rule 1844 for the customer HIJ 1814 specifies that only SequenceD, SequenceE, or SequenceF in Service3 are productive (with other interactions in Service3 being non-productive). A productivity rule 1846 specifies that only SequenceG and SequenceH are non-productive in Service4 (with other sequences in Service4 being productive).

Instead of or in addition to defining productivity rules based on whether a service or a sequence is productive, a productivity rule can specify a productivity weight that indicates a level of productivity (e.g., as a percentage) of a sequence or use of a service. For example, a productivity rule 1850 for the customer ABC 1806 specifies that Sequences B and C in Service3 are 100% productive and other interactions with Service3 are 50% productive. As another example, a productivity rule 1852 for the customer DEF 1810 specifies that, for Service3,a sequence SeqA is 100% productive, a sequence SeqB is 80% productive, a sequence SeqC is 20% productive, and other uses of Service3 are 10% productive. A productivity rule 1854 for the customer DEF 1810 specifies that, for Service6, sequences that include “InteractionX” (e.g., a particular interaction) are 100% productive while other use of Service6 is 50% productive.

In some implementations, whether (or how much) service representative interactions are considered productive is based on a degree of match of service representative interactions to a defined sequence. For example, a productivity rule 1856 for the customer HIJ 1814 specifies that service representative interactions with Service 4 that match a particular sequence with greater than an 80% match are considered productive while other interactions with Service4 are considered nonproductive. A match or degree of match can be determined in different ways. For example, for some sequences, a match may be determined to occur if service representative interactions match a same number of steps in a same order as that defined by a productivity rule. In other cases, a certain threshold number of steps are to match (e.g., four out of five) for an 80% match to occur, for example, regardless of which four of the five steps match. In other cases, an amount of time spent performing a certain step is to occur for the interaction to be considered as a match to the productivity rule.

In some cases, a productivity level can be reduced by accounting for “counterproductive” actions. For instance, a subset of representative interactions may match those included in a defined sequence at a 100% match, but other representative interactions may be observed that are considered counterproductive (or a degree or weight of counterproductive). Accordingly, a 100% match or 100% productivity level may be reduced to account for the counterproductive actions. Counterproductive actions may be other sequences or events, or other aggregated data. For example, the system could detect that a representative deleted seventy characters out of one hundred initially-typed characters.

As another example, a productivity rule 1858 for the customer HIJ 1814 specifies that a productivity weight for a sequence of interactions with Service5 is equal to a degree of match of the interactions to a defined sequence. For instance, if a sequence of interactions matches the defined sequence with a degree of match of 70%, the sequence of interactions can be considered 70% productive.

In some cases, a sequence specified in a productivity rule as productive can mean that a time duration of the sequence is considered to be productive (with other use of the service considered non-productive). A sequence can include a start interaction and an end interaction and possibly other interactions, and productive time can include time spent from the start action to the end interaction. In some cases, a rule can specify that if one or more particular sequences occur during use of a service, the entire use of the service is productive (e.g., including time spent on interactions with the service that may occur before or after the particular sequence).

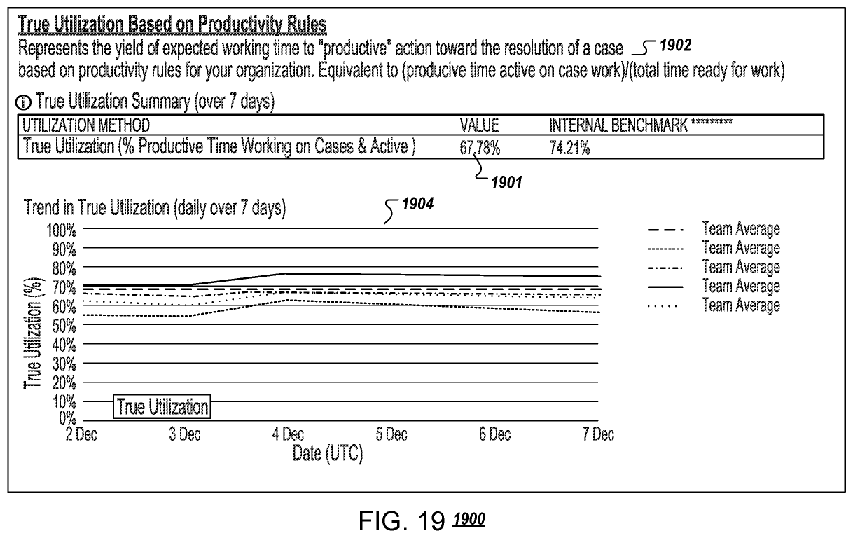

FIG. 19 is a screen shot showing an example of a true utilization page 1900 for determining true utilization based on productive behaviors. In contrast to the true utilization page 600 described above with respect to FIG. 6A, which displays a true utilization calculated based on active time, the true utilization page 1900 displays a true utilization metric 1901 which, as described by a note 1902, is calculated by dividing productive time active on case work by total time ready for work. A graph1904 displays true utilization values over a seven day period, for different teams. As described above, productive time may be based on sequences of interactions that are determined to be productive.

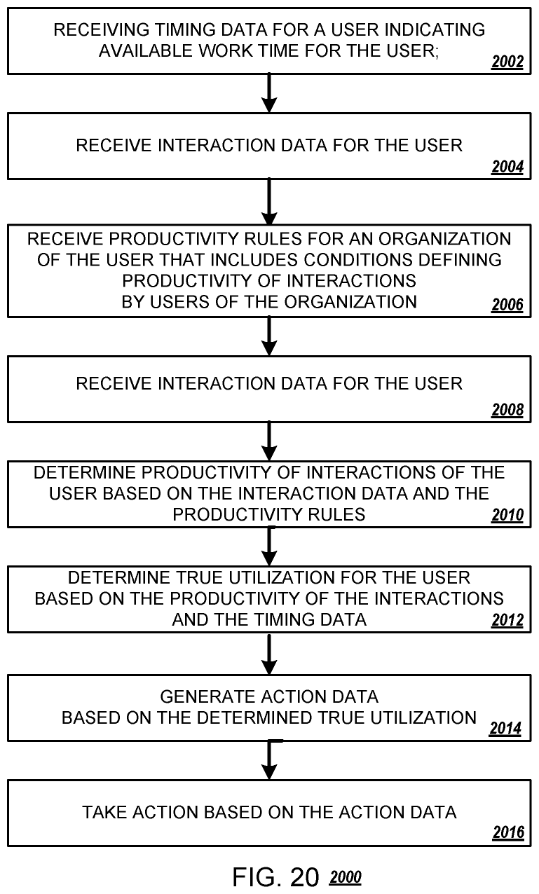

FIG. 20 is a flowchart of a method 2000 for determining true utilization based on productive behaviors of operators in a digital environment. For example, the true utilization engine 1702 can be used to perform the method 2000. For clarity of presentation, the description that follows generally describes method 2000 in the context of the other figures in this description. However, it will be understood that method 2000 can be performed, for example, by any suitable system, environment, software, and hardware, or a combination of systems, environments, software, and hardware, as appropriate. In some implementations, various steps of method 2000 can be run in parallel, in combination, in loops, or in any order.

The method 2000 can be performed to automatically determine productivity for each of multiple users of an organization. For example, productivity can be automatically determined for each customer support representative employed in the organization, for various periods (e.g., daily, weekly, monthly, annually). The method 2000 can be repeated for each respective user.

At 2002, timing data is received for a user that indicates available work time for the user. The user can be, for example, a customer support representative providing support for customers of the organization.

At 2004, interaction data for the user is received. The interactions can be performed in a digital workspace of the user. The interactions can be interactions occurring in multiple software services used by the user during the available work time for the user. The interactions can be part of sequences of interactions with a respective service.

At 2006, productivity rules are received for an organization of the user that include conditions that define productivity of interactions by users of the organization. Different organizations can have different productivity rules. The productivity rules can include sequence productivity rules that each include conditions defining productivity of a respective sequence of interactions with a respective service. The productivity rules can be configured by the organization or an administrator of a true utilization engine. As another example, the productivity rules can be part of a learned model learned by a machine learning engine. The learned model can be trained based on known productive interactions and known unproductive interactions. The learned model can be updated based on feedback on productivity data determined by the machine learning engine.

At 2008, productivity of interactions of the user is determined based on the interaction data and the productivity rules. For example, the interaction data can be matched to conditions specified in one or more productivity rules. As another example, the machine learning engine can determine productivity based on the learned model. Productivity can indicate whether time spent on certain interactions is productive or a degree of productivity.

At 2010, true utilization for the user is determined based on the productivity of the interactions and the timing data. True utilization can be determined by dividing a sum of time spent performing productive interactions divided by a sum of time available within the digital workspace of the user.

At 2012, action data is generated based on the determined true utilization.

At 2014, action is taken based on the action data. Taking action can include generating and providing a warning in response to the true utilization being less than a threshold. As another example, taking action can include performing one or more of a personnel action, a training, action, or a tool configuration action based on the action data. Action can be taken based on action data for a particular user or aggregate action data gathered for multiple users.

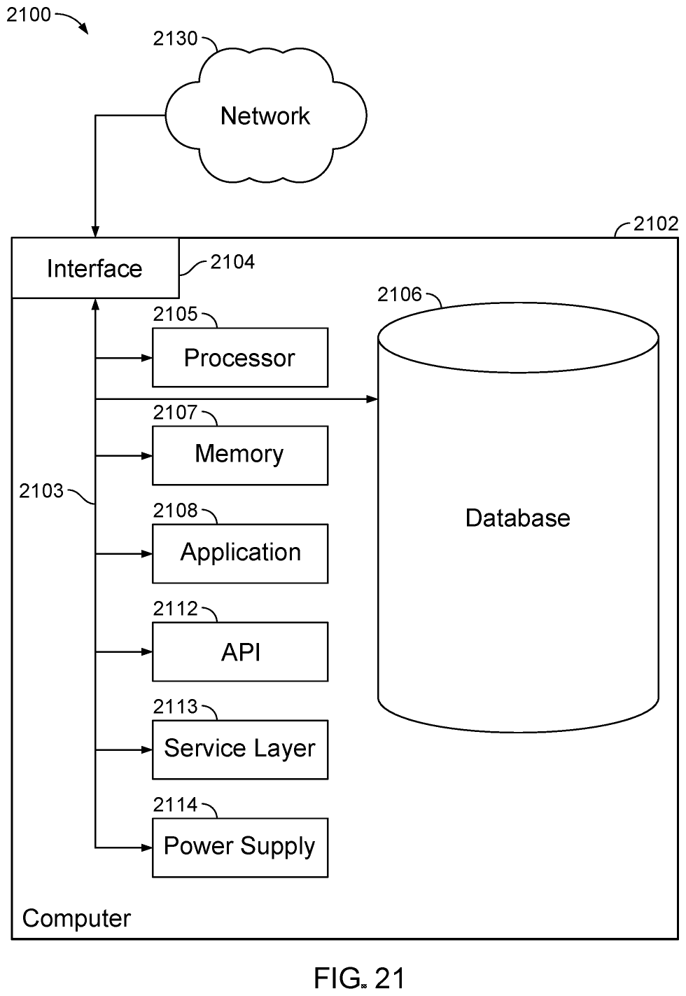

FIG. 21 is a block diagram of an example computer system 2100 used to provide computational functionalities associated with described algorithms, methods, functions, processes, flows, and procedures described in the present disclosure, according to some implementations of the present disclosure. The illustrated computer 2102 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 2102 can include input devices such as keypads, keyboards, and touch screens that can accept user information. Also, the computer 2102 can include output devices that can convey information associated with the operation of the computer 2102. The information can include digital data, visual data, audio information, or a combination of information. The information can be presented in a graphical user interface (UI) (or GUI).

The computer 2102 can serve in a role as a client, a network component, a server, a database, a persistency, or components of a computer system for performing the subject matter described in the present disclosure. The illustrated computer 2102 is communicably coupled with a network 2130. In some implementations, one or more components of the computer 2102 can be configured to operate within different environments, including cloud-computing-based environments, local environments, global environments, and combinations of environments.

At a top level, the computer 2102 is an electronic computing device operable to receive, transmit, process, store, and manage data and information associated with the described subject matter. According to some implementations, the computer 2102 can also include, or be communicably coupled with, an application server, an email server, a web server, a caching server, a streaming data server, or a combination of servers.

The computer 2102 can receive requests over network 2130 from a client application (for example, executing on another computer 2102). The computer 2102 can respond to the received requests by processing the received requests using software applications. Requests can also be sent to the computer 2102 from internal users (for example, from a command console), external (or third) parties, automated applications, entities, individuals, systems, and computers.

Each of the components of the computer 2102 can communicate using a system bus 2103. In some implementations, any or all of the components of the computer 2102, including hardware or software components, can interface with each other or the interface 2104 (or a combination of both) over the system bus 2103. Interfaces can use an application programming interface (API) 2112, a service layer 2113, or a combination of the API 2112 and service layer 2113. The API 2112 can include specifications for routines, data structures, and object classes. The API 2112 can be either computer-language independent or dependent. The API 2112 can refer to a complete interface, a single function, or a set of APIs.

The service layer 2113 can provide software services to the computer 2102 and other components (whether illustrated or not) that are communicably coupled to the computer 2102. The functionality of the computer 2102 can be accessible for all service consumers using this service layer. Software services, such as those provided by the service layer 2113, can provide reusable, defined functionalities through a defined interface. For example, the interface can be software written in JAVA, C++, or a language providing data in extensible markup language (XML) format. While illustrated as an integrated component of the computer 2102, in alternative implementations, the API 2112 or the service layer 2113 can be stand-alone components in relation to other components of the computer 2102 and other components communicably coupled to the computer 2102. Moreover, any or all parts of the API 2112 or the service layer 2113 can be implemented as child or sub-modules of another software module, enterprise application, or hardware module without departing from the scope of the present disclosure.

The computer 2102 includes an interface 2104. Although illustrated as a single interface 2104 in FIG. 21, two or more interfaces 2104 can be used according to particular needs, desires, or particular implementations of the computer 2102 and the described functionality. The interface 2104 can be used by the computer 2102 for communicating with other systems that are connected to the network 2130 (whether illustrated or not) in a distributed environment. Generally, the interface 2104 can include, or be implemented using, logic encoded in software or hardware (or a combination of software and hardware) operable to communicate with the network 2130. More specifically, the interface 2104 can include software supporting one or more communication protocols associated with communications. As such, the network 2130 or the interface's hardware can be operable to communicate physical signals within and outside of the illustrated computer 2102.

The computer 2102 includes a processor 2105. Although illustrated as a single processor 2105 in FIG. 21, two or more processors 2105 can be used according to particular needs, desires, or particular implementations of the computer 2102 and the described functionality. Generally, the processor 2105 can execute instructions and can manipulate data to perform the operations of the computer 2102, including operations using algorithms, methods, functions, processes, flows, and procedures as described in the present disclosure.

The computer 2102 also includes a database 2106 that can hold data for the computer 2102 and other components connected to the network 2130 (whether illustrated or not). For example, database 2106 can be an in-memory, conventional, or a database storing data consistent with the present disclosure. In some implementations, database 2106 can be a combination of two or more different database types (for example, hybrid in-memory and conventional databases) according to particular needs, desires, or particular implementations of the computer 2102 and the described functionality. Although illustrated as a single database 2106 in FIG. 21, two or more databases (of the same, different, or combination of types) can be used according to particular needs, desires, or particular implementations of the computer 2102 and the described functionality. While database 2106 is illustrated as an internal component of the computer 2102, in alternative implementations, database 2106 can be external to the computer 2102.

The computer 2102 also includes a memory 2107 that can hold data for the computer 2102 or a combination of components connected to the network 2130 (whether illustrated or not). Memory 2107 can store any data consistent with the present disclosure. In some implementations, memory 2107 can be a combination of two or more different types of memory (for example, a combination of semiconductor and magnetic storage) according to particular needs, desires, or particular implementations of the computer 2102 and the described functionality. Although illustrated as a single memory 2107 in FIG. 21, two or more memories 2107 (of the same, different, or combination of types) can be used according to particular needs, desires, or particular implementations of the computer 2102 and the described functionality. While memory 2107 is illustrated as an internal component of the computer 2102, in alternative implementations, memory 2107 can be external to the computer 2102.

The application 2108 can be an algorithmic software engine providing functionality according to particular needs, desires, or particular implementations of the computer 2102 and the described functionality. For example, application 2108 can serve as one or more components, modules, or applications. Further, although illustrated as a single application 2108, the application 2108 can be implemented as multiple applications 2108 on the computer 2102. In addition, although illustrated as internal to the computer 2102, in alternative implementations, the application 2108 can be external to the computer 2102.

The computer 2102 can also include a power supply 2114. The power supply 2114 can include a rechargeable or non-rechargeable battery that can be configured to be either user- or non-user-replaceable. In some implementations, the power supply 2114 can include power-conversion and management circuits, including recharging, standby, and power management functionalities. In some implementations, the power-supply 2114 can include a power plug to allow the computer 2102l to be plugged into a wall socket or a power source to, for example, power the computer 2102 or recharge a rechargeable battery.

There can be any number of computers 2102 associated with, or external to, a computer system containing computer 2102, with each computer 2102 communicating over network 2130. Further, the terms “client,” “user,” and other appropriate terminology can be used interchangeably, as appropriate, without departing from the scope of the present disclosure. Moreover, the present disclosure contemplates that many users can use one computer 2102 and one user can use multiple computers 2102.

Described implementations of the subject matter can include one or more features, alone or in combination. For example, in a first implementation, a computer-implemented method includes the actions of: automatically determining productivity for each of multiple users of an organization, wherein determining productivity for a respective user comprises: receiving timing data for the user indicating available work time for the user; receiving interaction data for the user for interactions occurring in multiple software services used by the user during the available work time for the user; receiving productivity rules for an organization of the user that include conditions defining productivity of interactions by users of the organization; determining productivity of interactions of the user based on the interaction data and the productivity rules; determining true utilization for the user based on the productivity of the interactions and the timing data; and generating action data based on the determined true utilization; and taking action based on the action data.

In a second implementation, a non-transitory, computer-readable medium stores one or more instructions executable by a computer system to perform operations including: automatically determining productivity for each of multiple users of an organization, wherein determining productivity for a respective user comprises: receiving timing data for the user indicating available work time for the user; receiving interaction data for the user for interactions occurring in multiple software services used by the user during the available work time for the user; receiving productivity rules for an organization of the user that include conditions defining productivity of interactions by users of the organization; determining productivity of interactions of the user based on the interaction data and the productivity rules; determining true utilization for the user based on the productivity of the interactions and the timing data; and generating action data based on the determined true utilization; and taking action based on the action data.

In a fourth implementation, a system comprises one or more computers and one or more storage devices on which are stored instructions that are operable, when executed by the one or more computers, to cause the one or more computers to perform operations. The operations include: automatically determining productivity for each of multiple users of an organization, wherein determining productivity for a respective user comprises: receiving timing data for the user indicating available work time for the user; receiving interaction data for the user for interactions occurring in multiple software services used by the user during the available work time for the user; receiving productivity rules for an organization of the user that include conditions defining productivity of interactions by users of the organization; determining productivity of interactions of the user based on the interaction data and the productivity rules; determining true utilization for the user based on the productivity of the interactions and the timing data; and generating action data based on the determined true utilization; and taking action based on the action data.

The foregoing and other described implementations can each, optionally, include one or more of the following features:

A first feature, combinable with any of the following features, wherein the interactions are performed in a digital workspace of the user.

A second feature, combinable with any of the previous or following features, wherein determining the productivity of the interactions of the user based on the interaction data and the productivity rules comprises determining a degree of match between interactions in the interaction data and one or more conditions in the productivity rules that define criteria for productive or nonproductive work.

A third feature, combinable with any of the previous or following features, wherein true utilization is determined by dividing a sum of time spent performing productive interactions divided by a sum of time available within the digital workspace of the user.

A fourth feature, combinable with any of the previous or following features, wherein the user is a customer support representative providing support for customers of the organization.

A fifth feature, combinable with any of the previous or following features, wherein different organizations have different productivity rules.

A sixth feature, combinable with any of the previous or following features, wherein: the interactions comprise sequences of interactions with a respective service; and the productivity rules include sequence productivity rules that each include conditions defining productivity of a respective sequence of interactions with a respective service.

A seventh feature, combinable with any of the previous or following features, wherein the productivity rules are configured by the organization.

An eighth feature, combinable with any of the previous or following features, wherein the productivity rules are part of a learned model learned by a machine learning engine.

A ninth feature, combinable with any of the previous or following features, wherein the learned model is trained based on known productive interactions and known unproductive interactions.

A tenth feature, combinable with any of the previous or following features, wherein the learned model is updated based on feedback on productivity data determined by the machine learning engine.

An eleventh feature, combinable with any of the previous or following features, wherein taking action comprises generating and providing a warning in response to the true utilization being less than a threshold.

A twelfth feature, combinable with any of the previous or following features, wherein taking action comprises performing one or more of a personnel action, a training, action, or a tool configuration action based on the action data.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
automatically determining productivity for each of multiple users of an organization, wherein determining productivity for a respective user comprises:
receiving timing data for the user indicating available work time for the user;
receiving interaction data for the user for interactions occurring in multiple software services used by the user during the available work time for the user;
receiving productivity rules for an organization of the user that include conditions defining productivity of interactions by users of the organization;
determining productivity of interactions of the user based on the interaction data and the productivity rules;
determining true utilization for the user based on the productivity of the interactions and the timing data; and
generating action data based on the determined true utilization; and
taking action based on the action data.

2. The computer-implemented method of claim 1, wherein the interactions are performed in a digital workspace of the user.

3. The computer-implemented method of claim 1, wherein determining the productivity of the interactions of the user based on the interaction data and the productivity rules comprises determining a degree of match between interactions in the interaction data and one or more conditions in the productivity rules that define criteria for productive or nonproductive work.

4. The computer-implemented method of claim 2, wherein true utilization is determined by dividing a sum of time spent performing productive interactions divided by a sum of time available within the digital workspace of the user.

5. The computer-implemented method of claim 1, wherein the user is a customer support representative providing support for customers of the organization.

6. The computer-implemented method of claim 1, wherein different organizations have different productivity rules.

7. The computer-implemented method of claim 6, wherein:
the interactions comprise sequences of interactions with a respective service; and
the productivity rules include sequence productivity rules that each include conditions defining productivity of a respective sequence of interactions with a respective service.

8. The computer-implemented method of claim 1, wherein the productivity rules are configured by the organization.

9. The computer-implemented method of claim 1, wherein the productivity rules are part of a learned model learned by a machine learning engine.

10. The computer-implemented method of claim 8, wherein a learned model is trained based on known productive interactions and known unproductive interactions.

11. The computer-implemented method of claim 8, wherein a learned model is updated based on feedback on productivity data determined by a machine learning engine.

12. The computer-implemented method of claim 1, wherein taking action comprises generating and providing a warning in response to the true utilization being less than a threshold.

13. The computer-implemented method of claim 1, wherein taking action comprises performing one or more of a personnel action, a training, action, or a tool configuration action based on the action data.

14. One or more computer-readable storage media encoded with instructions that, when executed by one or more computers, cause the one or more computers to perform operations comprising:
automatically determining productivity for each of multiple users of an organization, wherein determining productivity for a respective user comprises:
receiving timing data for the user indicating available work time for the user;
receiving interaction data for the user for interactions occurring in multiple software services used by the user during the available work time for the user;
receiving productivity rules for an organization of the user that include conditions defining productivity of interactions by users of the organization;
determining productivity of interactions of the user based on the interaction data and the productivity rules;
determining true utilization for the user based on the productivity of the interactions and the timing data; and
generating action data based on the determined true utilization; and
taking action based on the action data.

15. The computer-readable storage media of claim 14, wherein the interactions are performed in a digital workspace of the user.

16. The computer-readable storage media of claim 14, wherein determining the productivity of the interactions of the user based on the interaction data and the productivity rules comprises determining a degree of match between interactions in the interaction data and one or more conditions in the productivity rules that define criteria for productive or nonproductive work.

17. The computer-readable storage media of claim 16, wherein true utilization is determined by dividing a sum of time spent performing productive interactions divided by a sum of time available within a digital workspace of the user.

18. A system comprising: one or more computers and one or more storage devices on which are stored instructions that are operable, when executed by the one or more computers, to cause the one or more computers to perform operations comprising:
automatically determining productivity for each of multiple users of an organization, wherein determining productivity for a respective user comprises:
receiving timing data for the user indicating available work time for the user;
receiving interaction data for the user for interactions occurring in multiple software services used by the user during the available work time for the user;
receiving productivity rules for an organization of the user that include conditions defining productivity of interactions by users of the organization;
determining productivity of interactions of the user based on the interaction data and the productivity rules;
determining true utilization for the user based on the productivity of the interactions and the timing data; and
generating action data based on the determined true utilization; and
taking action based on the action data.

19. The system of claim 18, wherein the interactions are performed in a digital workspace of the user.

20. The system of claim 18, wherein determining the productivity of the interactions of the user based on the interaction data and the productivity rules comprises determining a degree of match between interactions in the interaction data and one or more conditions in the productivity rules that define criteria for productive or nonproductive work.
